(19) United States
(12) Patent Application Publication
(10) Pub. No.: US 2025/0036589 A1
(43) Pub. Date: Jan. 30, 2025

(54) HETEROGENEOUS ACCELERATED COMPUTE

(71) Applicant: ABACUS SEMICONDUCTOR CORPORATION, Pacifica, CA (US)

(72) Inventor: Axel K. KLOTH, Pacifica, CA (US)

(73) Assignee: ABACUS SEMICONDUCTOR CORPORATION, Pacifica, CA (US)

(21) Appl. No.: 18/784,787

(22) Filed: Jul. 25, 2024

Related U.S. Application Data
(60) Provisional application No. 63/528,878, filed on Jul. 25, 2023.

(51) Int. Cl. G06F 13/40; G06F 12/02; G06F 13/16

(52) U.S. Cl. CPC G06F 13/4022; G06F 12/0292; G06F 13/1668

(57) ABSTRACT

A new system architecture for servers used in supercomputers uses an on-chip switch fabric with backpressure to improve performance. A server-on-a-chip includes one or more of the on-chip switch fabrics coupling one or more processing cores enabled to respond to the backpressure. Optionally, one or more ports of the on-chip switch fabrics are used to provide (external) ports of the server-on-a-chip to enable seamless communication with other server-on-a-chip instances. Various instances of the server-on-a-chip use the seamless communication to communicate with each other over a single printed circuit board and/or with each other across a plurality of printed circuit boards. Optional smart memory and/or multi-homed memory techniques improve memory efficiency by posting all writes, hiding DRAM maintenance operations (e.g., refresh, scrubbing, error correction and/or error logging), and/or reducing attack vectors, such as via secure booting of encrypted boot images.

### PRIORITY APPLICATIONS

This application claims the benefit of and priority to U.S. Provisional Patent Application No. 63/528,878, titled “SYSTEM ARCHITECTURE FOR SUPERCOMPUTER SERVERS”, filed Jul. 25, 2023 (Atty Docket No. ABCS 1000-1), which is incorporated by reference herein in its entirety.

### BACKGROUND

### Field

This disclosure relates to supercomputer server architecture.

### Description of Related Art

Existing supercomputers are built based on industry-standard Commercial Off-The-Shelf (COTS) processors and General-Purpose Graphics Processing Unit (GPGPU) accelerators in COTS servers, without enhancements to provide high-bandwidth and low-latency communication between processors, accelerators, and memory. Thus, their performance does not scale out linearly over the number of cores, even while ever more supercomputing performance is needed. Adding more processor cores is wasteful, as much of their capacity is wasted on interconnect in massively parallel systems. Further, cost and power increase dramatically. Inclusion of accelerators is inefficient, such as measured by cost and/or performance.

Compute eXpress Link (CXL) is proposed to address memory scale-out. Universal Chiplet Interconnect express (UCIe) is proposed to address integration of different parts of a processor across multiple chiplets to improve performance, power, and Input/Output (I/O) capabilities.

However, neither CXL nor UCIe address the underlying problems.

In existing supercomputer servers, latency between components is too high. For examples, latency between components (e.g., CPU cores) within a chip (intra-chip), on different chips (inter-chip) on either a same Printed Circuit Board (PCB) or different PCBs (intra-board and inter-board, respectively), is too high and limits performance.

In existing supercomputer servers, memory technology introduces inefficiencies such as non-uniform performance (e.g., due to memory refresh and/or scrubbing, and non-contiguous physical addressing), lack of resilience, security, and/or fault tolerance, and lack of efficient sharing techniques.

A new system architecture for supercomputer servers is needed to address the foregoing.

### SUMMARY

The new system architecture for supercomputer servers addresses the foregoing, as described following.

### BRIEF DESCRIPTION OF THE DRAWINGS

FIG. 1A illustrates various aspects of a Server-on-a-Chip and a boot resource.

FIG. 1B illustrates an example system architecture.

FIG. 2A illustrates various aspects of a Server-on-a-Chip directed to mass storage usage scenarios.

FIG. 2B illustrates various aspects of a server-on-a-chip for a 5G proxy appliance.

FIG. 2C illustrates various aspects of a server-on-a-chip for a storage appliance.

FIG. 3 illustrates various aspects of a Server-on-a-Chip directed to offload Network Interface Card (NIC) usage scenarios.

FIG. 4 illustrates various aspects of a Server-on-a-Chip system.

FIG. 5A illustrates various aspects of a Server-on-a-Chip heterogeneous system.

FIG. 5B illustrates various aspects of a CXL-Based System.

FIG. 6A illustrates various aspects of a Server-on-a-Chip multiprocessor system.

FIG. 6B illustrates various aspects of a multiprocessor system.

FIG. 7 illustrates various aspects of a Server-on-a-Chip heterogeneous multiprocessor system.

FIG. 8 illustrates various aspects of a Server-on-a-Chip communications stack.

FIG. 9A illustrates various aspects of Server-on-a-Chip chiplet-based interface round trip time and bandwidth.

FIG. 9B illustrates various aspects of Server-on-a-Chip UCIe chiplet-based interface round trip time.

FIG. 10 illustrates various aspects of a Server-on-a-Chip switch fabric.

FIG. 11 illustrates various aspects of inter-processor communication using an off-chip ccNUMA switch.

FIG. 12 illustrates various aspects of a Server-on-a-Chip boot flow.

FIG. 13 illustrates various aspects of a system using a Server-on-a-Chip. A switch enables the CPU core to couple to multi-homed memory, other CPUs, and accelerators as peers on the switch. Integration of the switch on a same integrated circuit die as the CPU core enables low-latency communication between the CPU core and other elements. As an example, the switch as well as the components coupled to it are implemented using backpressure as described elsewhere herein.

FIG. 14 illustrates various aspects of Princeton (von Neumann) architecture.

FIG. 15 illustrates various aspects of a Harvard architecture.

FIG. 16 illustrates various aspects of software and Application Programming Interface (API) elements for a system using a Server-on-a-Chip and/or a supercomputer server.

### DETAILED DESCRIPTION

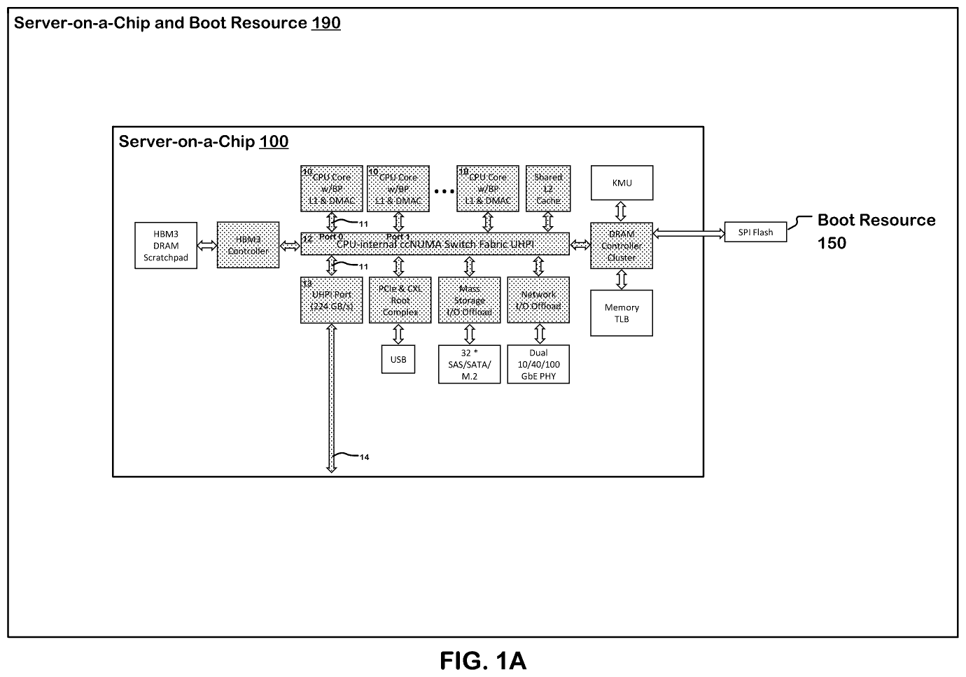

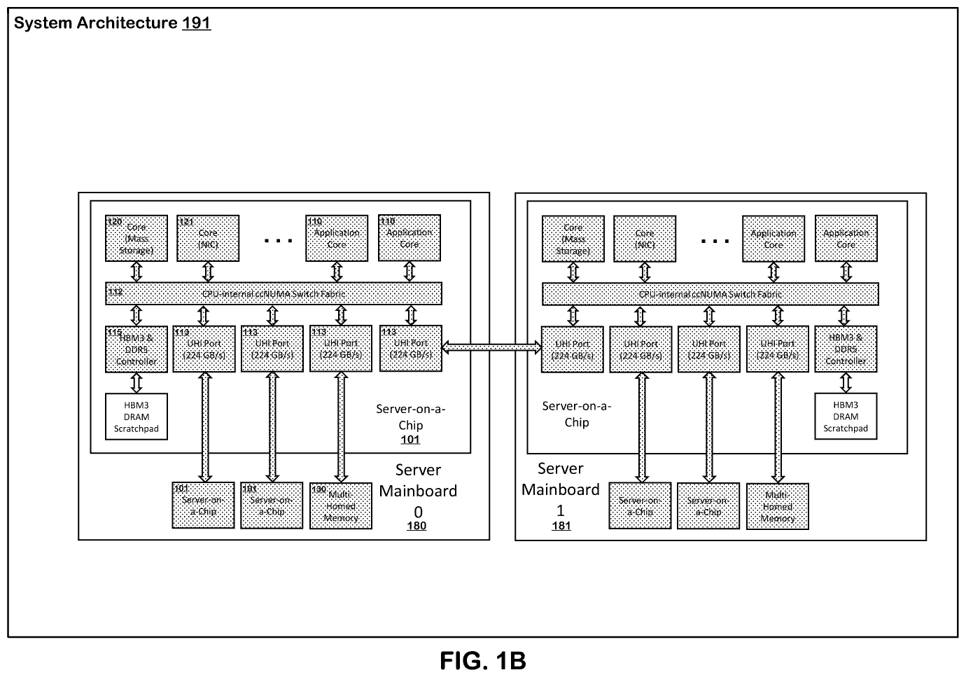

A detailed description of techniques relating to supercomputer server architecture follows, with references to FIGS. 1-16.

One or more flow diagrams are described herein. Processing described by the flow diagrams is implementable and/or directable using processors programmed using computer programs stored in memory accessible to computer systems and executable by the processors, using dedicated logic hardware (including field programmable integrated circuits), and using various combinations thereof. Various actions are combinable, performable in parallel, and/or performable in a different sequence without affecting processing achieved. In some cases, a rearrangement of actions achieves identical results only if certain other changes are made as well. In other cases, a rearrangement of actions achieves identical results only if certain conditions are satisfied. Furthermore, for clarity, some of the flow diagrams herein omit certain some actions not necessary for understanding the disclosed techniques. Various additional actions are performable before, after, and/or between the illustrated actions.

Throughout the description herein, as well as the associated figures, like-numbered elements correspond to identical elements, substantially similar elements, and/or instances thereof.

Examples of selected acronyms, mnemonics, and abbreviations used in the description are as follows.

(Acronym/Mnemonic/Abbreviation) Example

(API) Application Programming Interface
(BIOS) Basic Input/Output System
(BP) BackPressure
(BW) BandWidth
(ccNUMA) cache-coherent Non-Uniform Memory Access
(COTS) Commercial Off-The-Shelf
(CPU) Central Processing Unit
(CXL) Compute eXpress Link
(DDR4) Double Data Rate Fourth Generation Synchronous Dynamic Random-Access
Memory
(DDR5) Double Data Rate Fifth Generation Synchronous Dynamic Random-Access Memory
(DIMM) Dual In-line Memory Module
(DMA) Direct Memory Access
(DMAC) Direct Memory Access Controller
(DRAM) Dynamic Randomly Accessible read-write Memory aka dynamic volatile memory
(DTO) Data Transfer Offload
(FEA) Finite Element Analysis
(FEM) Finite Element Method
(GPGPU) General-Purpose Graphics Processing Unit
(GPU) Graphics Processing Unit
(HBM) High-Bandwidth Memory
(HPC) High-Performance Computing
(I/O) Input/Output
(IOMMU) Input/Output Memory Management Unit
(IRQ) Interrupt ReQuest
(ISA) Instruction Set Architecture
(JEDEC) Joint Electron Device Engineering Council
(KMU) Key Material Unit
(M.2) aka Next Generation Form Factor (NGFF)
(MCM) Multi-Chip Module
(MESI) Modified Exclusive Shared Invalid
(MMU) Memory Management Unit
(MOESI) Modified Owned Exclusive Shared Invalid
(MP) MultiProcessor
(NOC) Network on a Chip
(NVMe) Non-Volatile Memory Express
(NVRAM) Non-Volatile Randomly Accessible Memory
(OS) Operating System
(PCB) Printed Circuit Board
(PCIe) Peripheral Component Interconnect express
(PCM) Phase Change Memory
(PHY) PHYsical layer
(RAM) Randomly Accessible read-write Memory aka volatile/non-volatile memory
(RISC) Reduced Instruction Set Computer
(ROM) Read-Only Memory aka non-volatile memory
(RTT) Round Trip Time
(SAS) Serial Attached SCSI (Small Computer System Interface)
(SATA) Serial Advanced Technology Attachment
(SerDes) Serializer/Deserializer
(SF) Switch Fabric
(SMP) Symmetric MultiProcessor
(SPI) Serial Peripheral Interconnect
(SRAM) Static Randomly Accessible read-write Memory aka static volatile memory
(SSD) Solid-State Drive
(TLB) Translation Lookaside Buffer
(TSV) Through Silicon Via
(UCIe) Universal Chiplet Interconnect express
(UEFI) Unified Extensible Firmware Interface
(UHPI) Universal High-Performance Interconnect
(USB) Universal Synchronous Bus

HBM3 (High Bandwidth Memory 3) is a third generation of the HBM architecture that stacks DRAM chiplets one above another, interconnecting the chiplets by vertical current-carrying holes (e.g., through silicon vias) to for example, a base interposer board, via connecting micro-bumps. The base interposer board (such as an element of an MCM) optionally includes other components, such as a server-on-a-chip enabled to access the DRAM faster than would otherwise be possible using a socket interface for the server-on-a-chip.

### Supercomputer Server Architecture Overview

In this new system architecture for supercomputer servers, latency between components is reduced by accelerated signaling of BackPressure (BP) between components. As various examples, intra-chip, inter-chip, intra-board, and inter-board latency between CPU cores is reduced by accelerated signaling between one or more Switch Fabrics (SFs) that couple the CPU cores and the CPU cores themselves. The accelerated BP enables smaller queues and/or buffers on communication paths, thereby reducing latency and reducing contention in the SFs.

The accelerated BP signaling occurs responsive to a queue of the SF filling to a first watermark. An indication of the queue filling to the first watermark is distributed by the SF to all components that contributed to the queue filling. In response, the components cease sending information to the queue. The accelerated BP signally further occurs responsive to the queue emptying to a second watermark. An indication of the queue emptying to the second watermark is distributed by the SF to all components that received the indication of the first watermark. In response, the components enable sending further information (as it is available) to the queue. The accelerated BP signaling is communicated directly to all components that have at least one entry in the queue, without an intermediate switch that is distinct from the components. The queue is variously a systolic array or a circular buffer. In certain scenarios, a circular buffer is used for queues that are deeper than, e.g., 16 entries.

Signaling BP within a first predetermined number of cycles of a queue filling to a first watermark and within a second predetermined number of cycles of the queue emptying to a second watermark enables reduced latency and reduced contention for components interconnected by SFs. The predetermined BP signaling latency enables interconnection of components of various types (e.g., processors, memories, and/or interfaces), bandwidths, and latencies by SFs, such as SFs built into the components themselves. The built in SFs reduce how many layers of interfaces information traverses between the components, reducing latency.

In this new system architecture for supercomputer servers, improved internal and external interconnect increases linear scalability. The improved interconnect enables lower latency, higher bandwidth, and traversal of fewer components for inter-processor communication. The inter-processor communication is explicit, such as between processing elements proper (e.g., between CPU cores, between accelerators, and/or between CPU cores and accelerators), as well as implicit such as between the processing elements and memory elements.

In this new system architecture for supercomputer servers, a ccNUMA switch with reduced contention (e.g., by using BP) improves internal interconnects among cores on a same die. In this new system architecture for supercomputer servers, switch fabrics with reduced contention (e.g., by using BP) improve external interconnects among CPU cores, accelerators, and memory.

In this new system architecture for supercomputer servers, a unified interface between the accelerators and other processing elements (such as accelerators of various types as well as CPU cores and/or memory elements) provides for efficient inclusion of accelerators (e.g., as measured by cost and/or performance).

In this new system architecture for supercomputer servers, smart memory improves memory technology efficiency. For example, the smart memory addresses non-uniform memory performance (e.g., due to memory refresh and/or scrubbing) by posting writes without regard to physical address, virtual address, and/or metadata associated with the address.

For another example, the smart memory addresses non-uniform memory performance (e.g., due to non-contiguous physical addressing) by mapping one or more memory components (e.g., DRAM or NVRAM DIMM) physical addresses into one or more contiguous physically addressable regions.

For another example, the smart memory addresses resilience and/or fault tolerance by the smart memory autonomously determining, logging, and/or mapping out unreliable and/or failing portions of the memory components, such as in conjunction with maintaining the contiguous physically addressable regions for the memory components.

For another example, the smart memory addresses security by encrypting BIOS, UEFI, and/or boot code, as well as providing resistance to various memory-related attack vectors.

In this new system architecture for supercomputer servers, memory technology is improvable, e.g., with respect to sharing, by multi-homed memory. The multi-homed memory enables high-bandwidth/low-latency memory accesses for a plurality of channels. The multi-homed memory enables access to multiple hierarchies of memory technologies, such as SRAM, DRAM, and NVRAM. The multi-homed memory has a plurality of universal ports each enabled to connect (e.g., via an internal switch, an external switch, or both) to another component such as a CPU core, an accelerator, or another memory controller (such as an HBM3 controller or another multi-homed memory). Thus, multi-homed memory elements are enabled for cascading. Various multi-homed memory components optionally provide special purpose and/or direct connection elements.

Smart memory and multi-home memory techniques are combinable. Universal channels (e.g., as used to communicate memory commands to smart and/or multi-homed memory components) are enabled to communicate various types of memory commands. The various types of memory commands include malloc-style memory commands (e.g., originating from operating system kernel memory allocation/deallocation system calls), JEDEC chip-style memory commands (e.g., DDR4 and/or DDR5 commands), and/or JEDEC flash-style memory commands. An optional controller is enabled to convert DRAM JEDEC commands into flash JEDEC commands.

In various aspects, the new system architecture for servers used in supercomputers uses an on-chip switch fabric with backpressure to improve performance. A server-on-a-chip includes one or more of the on-chip switch fabrics coupling one or more processing cores enabled to respond to the backpressure. Optionally, one or more ports of the on-chip switch fabrics provide (external) ports of the server-on-a-chip to enable seamless communication with other server-on-a-chip instances. Various instances of the server-on-a-chip use the seamless communication to communicate with each other over a single printed circuit board and/or with each other across a plurality of printed circuit boards. Optional smart memory and/or multi-homed memory techniques improve memory efficiency by posting all writes, hiding DRAM maintenance operations (e.g., refresh, scrubbing, error correction and/or error logging), hiding flash maintenance operations (e.g., garbage collection, wear leveling related operations, error correcting, and error logging), and/or reducing attack vectors, such as via secure booting of encrypted boot images.

As a specific example of the new system architecture for supercomputer servers, a PCB (e.g., a mainboard) includes one or more server-on-a-chip multi-chip modules (MCMs) coupled together. A multi-board high-performance computing server includes two or more instances of the mainboard coupled to each other via electrical and/or optical links. The server-on-a-chip multi-chip module includes a plurality of CPU cores coupled by a cache-coherent non-uniform access switch that is optionally implemented on a same die as the CPU cores. The switch as well as the CPU cores and related memory hierarchy cooperatively use backpressure to prevent overrunning buffers associated with a switch fabric of the switch. Processing pipelines of the CPU cores, memory buffers, caches (e.g., L1, L2, L3, and so forth), and/or cache controllers are selectively and/or conditionally responsive to the backpressure. The switch fabric is non-blocking and has reduced contention via the backpressure. The switch fabric is optionally self-routing.

As another specific example of the new system architecture for supercomputer servers, a plurality of server-on-a-chip MCMs are in a 1U server configuration, e.g., on a half rack, providing 42 servers. Alternatively, the server-on-a-chip MCMs are in a 2U server configuration, providing 21 servers. In certain configurations, local communication on a board is performed by 14 of 16 ports, and non-local communication to ports on another board is performed by 2 of 16 ports, such as via electronic to optical transducers. The ports are usable to form any of a variety of inter-server networking configurations, such as ring, torus, mesh, bus, and/or switch fabric networking configurations, as well as combinations thereof, such as an overlay of two or more networking configurations (e.g., ring and torus).

A smart memory includes scratchpad DRAM and/or SRAM used to post all writes. A high-bandwidth memory controller couples the scratchpad to the switch. The smart memory further includes a plurality of DRAM chiplets coupled to the switch via a DRAM controller cluster. The smart memory is enabled to use otherwise idle DRAM cycles to move posted write data in the scratchpad to the DRAM controller cluster for writing into the DRAM chiplets. The smart memory further includes dedicated cryptographic key memory accessible by the DRAM controller cluster to autonomously provide a secure boot capability to the CPU cores.

The smart memory includes a dedicated processing resource operable as a command interpreter that intercepts memory commands from all components, interprets and performs the memory commands (e.g., to facilitate posted writes, caching, memory content integrity, sharing, and/or cache coherency). Conceptually, the dedicated processing resource functions as a processor memory controller that is shared by multiple components. The dedicated processing resource is optionally a reduced instruction set processor (such as a RISC V processor core) that interfaces with IOMMUs and DMACs.

The smart memory is enabled to map non-contiguous physical memory portions into one or more memory portions that appear contiguous to other agents. The mapping is via a TLB or a TLB-like data structure of the smart memory. The mapping frees resources that would otherwise be consumed by a processor memory controller and/or various operating system modules of code and data.

The smart memory is enabled to perform one or more cache-control protocols (e.g., MESI and/or MOESI cache-control protocols) via hardware. The smart memory is enabled to process scatter/gather operations and linked list operations, including copying data autonomously. The smart memory is enabled to perform autonomous error correction and logging, as well as blocking out bad memory. The smart memory enables system updates on running systems by mapping information to another CPU core.

The server-on-a-chip MCM includes one or more universal ports to enable connections to similarly enabled components. Various inter-CPU networking topologies are implementable using the universal ports, including a torus topology. The connections are usable to connect two adjacent server racks to each other. Communication between CPU cores of the server racks is cache coherent and transparent to software implemented for cache-coherent multiprocessor systems. The universal ports are enabled to cascade with one another to increase fanout. A multi-home memory is implemented as a multi-chip module having a plurality of the universal ports. The multi-home memory is enabled to respond to and provide smart memory functions transparently for a plurality of CPUs.

### Supercomputer Server Architecture Concepts

Supercomputer server architecture as described herein enables more nearly linear performance scale-out, such as measured by bandwidth, latency, and/or round-trip time. The supercomputer server architecture as described herein enables improved power envelopes and energy savings. The supercomputer server architecture as described herein enables improved integration of accelerators. The supercomputer server architecture as described herein enables improved reliability and available, as well as security (e.g., for data at rest, data in motion, and/or device security) with respect to access and administration functions.

Various elements of the supercomputer server architecture implement backpressure to prevent information loss. A source of information communicates the information to a sink. The information is, e.g., a stream of transactions. As the transactions arrive at the sink from the source, entries in a queue store the transactions until processing of the transactions is complete. As the sink processes the transactions, the entries are freed for receiving additional transactions from the source.

The queue has a limited number of entries. The sink continuously monitors how many of the entries are free (or alternatively how many are used). The sink prevents overflow of the queue by requesting, via backpressure, that the source cease sending transactions to the sink. The sink enables resumption of transactions from the source to the sink by releasing the backpressure to the sink.

The sink requests backpressure responsive to detecting that a high watermark number of entries of the queue are used. The sink releases backpressure responsive to detecting that a low watermark number of entries of the queue are used. For example, the high watermark corresponds to 50% of the entries of the queue being used, and the low watermark corresponds to 25% of the entries of the queue being used.

### Server-On-a-Chip Supercomputer Server Architecture

FIG. 1A illustrates various aspects of a Server-on-a-Chip and a boot resource, as Server-on-a-Chip and Boot Resource 190. Server-on-a-Chip and Boot Resource 190 comprises Server-on-a-Chip 100 coupled (e.g., via a serial interface) to Boot Resource 150. In the figure, stippled elements, e.g., CPU Core with BackPressure and L1 & DMAC 10, Coupling 11, CPU-internal ccNUMA Switch Fabric UHPI 12, UHPI Port 13, and so forth, indicate support for enhancements enabling improved performance. For example, CPU Core with BackPressure and L1 & DMAC 10, Coupling 11, CPU-internal ccNUMA Switch Fabric UHPI 12, UHPI Port 13, and so forth, support backpressure, enabling reduced contention in CPU-internal ccNUMA Switch Fabric UHPI 12.

Boot Resource 150 stores one or more boot images for use by Server-on-a-Chip 100 during boot, firmware verification and update, and other functions benefiting from non-volatile storage accessible by autonomous-capable memory control elements (e.g., the DRAM Controller Cluster). An example of Boot Resource 150 is an SPI flash device.

Server-on-a-Chip 100 is an example server-on-a-chip. Included elements enable processing, memory, and I/O functions. The processing functions are performed, e.g., by CPU Core with BackPressure and L1 & DMAC 10. The memory functions are performed, e.g., by the HBM3 Controller in conjunction with the HBM3 DRAM Scratchpad as well as the DRAM Controller Cluster in conjunction with KMU, Memory, TLB, and interface elements. The I/O functions are performed, e.g., by the controllers/interfaces to USB, SAS, SATA, M.2, NVMe, and Ethernet elements. CPU-internal ccNUMA Switch Fabric UHPI 12 couples various elements. CPU-internal ccNUMA Switch Fabric UHPI 12 enables cache-coherent, non-blocking, contention-free/contention-reduced communication between elements coupled to it. The communication extends to elements coupled off chip, e.g., via UHPI Port 13 and UHPI Port for External Coupling 14.

CPU-internal ccNUMA Switch Fabric UHPI 12 performs enhanced ccNUMA switching functions, including backpressure determination and communication. Couplings to CPU-internal ccNUMA Switch Fabric UHPI 12, such as instances of Coupling 11, enable communication of backpressure. The backpressure determination and communication enable reduced contention for switching resources of CPU-internal ccNUMA Switch Fabric UHPI 12. UHPI Port 13 provides for PCB-level communication between other instances of Server-on-a-Chip 100, as well as other elements with interfaces compatible with UHPI Port 13, such as another instance of Server-on-a-Chip 100 on a same PCB or more remotely, coupled, e.g., by optical and/or electrical links. The optical and/or electrical links are optionally coupled via UHPI Port for External Coupling 14.

CPU-internal ccNUMA Switch Fabric UHPI 12 and elements coupled to it enable topology self-discovery. The topology self-discovery is according to a number of hops over interfaces, such as topology self-discovery over two hops, three hops, four hops, and so forth.

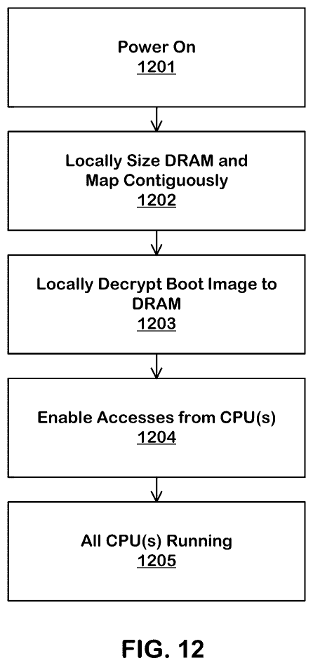

A smart memory capability is collectively provided by the HBM3 controller, the HBM3 DRAM Scratchpad, the DRAM Controller Cluster, the Memory TLB element, the KMU, and/or CPU-internal ccNUMA Switch Fabric UHPI 12. The smart memory capability enables secure boot from a boot image (e.g., from Boot Resource 150). The boot image is sharable by all the CPU Cores (e.g., instances of CPU Core with BackPressure and L1 & DMAC 10) coupled to the smart memory. (FIG. 12 and associated paragraphs describe various aspects of secure booting.) The smart memory capability enables improved resistance to various attack techniques, such as Spectre, Meltdown, Rowhammer, and HalfRow, e.g., by hiding underlying implementation details of memory. The Memory portion of the Memory TLB element comprises, e.g., DRAM chiplets). The TLB portion of the Memory TLB element is enabled to store mapping and tag information).

The smart memory capability provides for posting of all writes (e.g., by storing data associated with the writes to the HBM3 DRAM Scratchpad via the HBM3 Controller). All reads that miss in caches are satisfied first from the HBM3 DRAM scratchpad and lastly from the DRAM chiplets. The smart memory capability provides for storing metadata such as tags, coherency, and security information. The metadata indicates, e.g., memory that is not-executable, non-cacheable, non-write-combining, read-only, in a particular coherency state (e.g., according to a MESI or MOESI cache protocol, including modified, owned, shared, and exclusive states), and otherwise subject to specific processing. The smart memory uses the stored tag information to enable posting of all writes (even if, e.g., non-cacheable), and then to enable proper serialization and/or exception signaling of reads of the posted information in accordance with the tag information. Thus, via the metadata, the smart memory capability provides programmable coherence domains and improved security, as well as cache coherence.

CPU Core with BackPressure and L1 & DMAC 10 implements an ISA, such as in compliance with RISC (e.g., RISC V). CPU Core with BackPressure and L1 & DMAC 10 is pipelined and for example, operates caching mechanisms in-order, executes instructions out-of-order, and then reorders results of the instruction execution.

Server-on-a-Chip and Boot Resource 190 is implementable, e.g., as a PCB. Server-on-a-Chip 100 is implementable, e.g., as an MCM. In this context, the MCM is considered the “Chip” of Server-on-a-Chip 100. The MCM has a plurality of individual integrated circuit dice. Optionally, a portion of the dice are implemented and/or referred to as chiplets, such as the DRAM chiplets.

As one example, instances of CPU Core with BackPressure and L1 & DMAC 10, CPU-internal ccNUMA Switch Fabric UHPI 12, and the Shared L2 Cache are implemented as a first (integrated circuit) die. Continuing the example, the HBM3 Controller is implemented as a second die and the HBM3 DRAM Scratchpad is implemented on a plurality of HBM3 SRAM chiplets. Continuing the example, the DRAM Controller Cluster is implemented on a third die and the Memory portion of the Memory TLB element is implemented as a plurality of DRAM chiplets. Continuing the example, the remainder of the elements of Server-on-a-Chip 100 are variously implemented on one or more separate integrated circuit dice, chips, and/or chiplets, as appropriate according, e.g., to performance and/or cost objectives. Continuing the example, the MCM provides electrical coupling between the various integrated circuit dice and chiplets of Server-on-a-Chip 100, such as with wires, bump landings, through-hole vias, and other techniques for electrical coupling. Concluding the example, the MCM provides physical mounting and thermal conducting for the various integrated circuit dice and chiplets of Server-on-a-Chip 100.

As another example, each instance of CPU Core with BackPressure and L1 & DMAC 10 is implemented on a single die (or alternatively on one or more dice, one or more chips, and/or one or more chiplets) and CPU-internal ccNUMA Switch Fabric UHPI 12 and the Shared L2 Cache are implemented as another single die (or alternatively on one or more dice, one or more chips, and/or one or more chiplets).

### System Architecture

An example system architecture connects processors, accelerators, and smart multi-homed memory through low-latency, high-bandwidth unified interconnect. The interconnect is point-to-point (e.g., there is no shared bus and no multi-drop interconnect requiring arbitration). Each processor, accelerator, and smart multi-homed memory includes at least one respective internal switch fabric. The internal switch fabrics collectively enable core-to-core communications at low latency and high bandwidth, enabling more linear scale-out, across processors, accelerators, and smart multi-homed memories. In some scenarios, the processors and the accelerators have identical interfaces and/or identical pinouts.

FIG. 1B illustrates an example system architecture, as System Architecture 191. As in FIG. 1, stippled elements, e.g., Server on-a-Chip 101, Application Core 110, Core (Mass Storage) 120, Core (NIC) 121, UHI Port (224 GB/s) 113, Multi-Homed Memory 130, and so forth, support backpressure, enabling reduced contention in CPU-internal ccNUMA Switch Fabric 112. Each stippled double arrow indicates a FDX bidir connection at 224 GB/s that is enabled for trunking (aggregation).

System Architecture 191 includes two server mainboards (Server Mainboard 180 and Server Mainboard 1 181). Each main board includes a plurality of instances of Server on-a-Chip 101. Each instance of Server on-a-Chip 101 includes elements coupled to CPU-internal ccNUMA Switch Fabric 112, e.g., Core (Mass Storage) 120, Core (NIC) 121, multiple instances of Application Core 110, and multiple instances of UHI Port (224 GB/s) 113.

In some scenarios, System Architecture 191 is an example of a variation of Server-on-a-Chip and Boot Resource 190 of FIG. 1A. For example, Server on-a-Chip 101 is a variation of Server-on-a-Chip 100 of FIG. 1A. For another example, CPU-internal ccNUMA Switch Fabric 112, Application Core 110, and UHI Port (224 GB/s) 113 are respectively variations of q12, q10, and/or q13 of FIG. 1A. In some scenarios, Core (Mass Storage) 120 and/or Core (NIC) 121 are respectively variations and/or specializations of Application Core 110. In some variations, each of the processing cores (Core (Mass Storage) 120, Core (NIC) 121, and instances of Application Core 110), each of the memory controllers (HBM3 & DDR5 Controller 115) include at least one respective non-blocking switch fabric that supports backpressure. The non-blocking switch fabrics collectively enable (in part) support of backpressure to enable reduced contention in CPU-internal ccNUMA Switch Fabric 112.

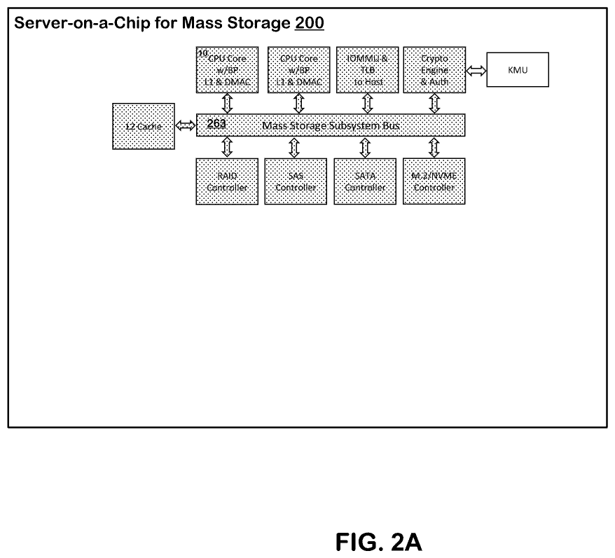

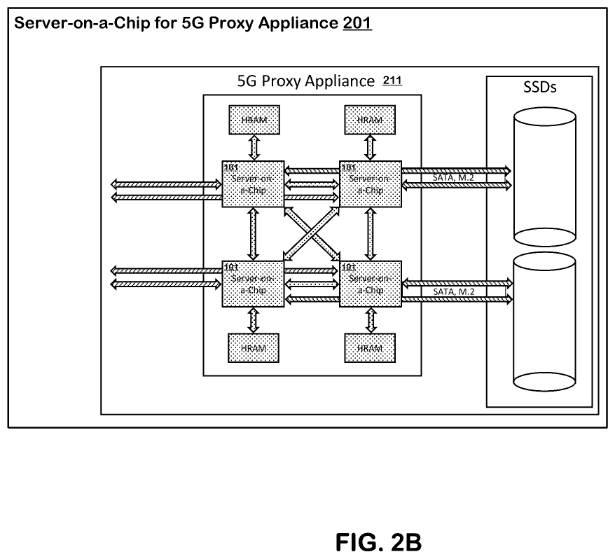

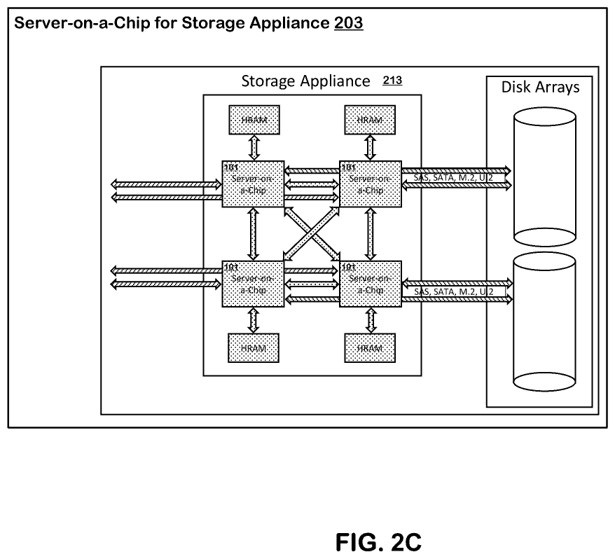

FIG. 2A illustrates various aspects of a Server-on-a-Chip directed to mass storage usage scenarios, as Server-on-a-Chip for Mass Storage 200. As in FIG. 1, stippled elements, e.g., Mass Storage Subsystem Bus 263 and elements coupled to it, indicate support for enhancements (such as backpressure) enabling improved performance. In certain variations, Mass Storage Subsystem Bus 263 is enabled to perform functions for cache-coherency, backpressure, and/or other operations to facilitate enhanced performance. In certain variations, Mass Storage Subsystem Bus 263 is similar to CPU-internal ccNUMA Switch Fabric UHPI 12. In certain variations, Server-on-a-Chip for Mass Storage 200 is a server-on-a-chip design, based, for example, on Server-on-a-Chip 100 of FIG. 1. Server-on-a-Chip for Mass Storage 200 is usable as an example of a mass storage subsystem for a server-on-a-chip.

FIG. 2B illustrates various aspects of a server-on-a-chip for a 5G proxy appliance as Server-on-a-Chip for 5G Proxy Appliance 201. Server-on-a-Chip for 5G Proxy Appliance 201 includes 5G Proxy Appliance 211 coupled to a plurality of SSDs and providing connectivity via, e.g., Ethernet couplings. Each stippled double arrow indicates a FDX bidir connection at 224 GB/s that is enabled for trunking (aggregation). Each forward-slash patterned double arrow indicates a 10/40/100 GbE connection; there are four total. Each backward-slash patterned double arrow indicates a mass storage connection, including CXL; there are four total. Each instance of Server on-a-Chip 101 and each HRAM component each have 4 UHI ports.

FIG. 2C illustrates various aspects of a server-on-a-chip for a storage appliance as Server-on-a-Chip for Storage Appliance 203. Server-on-a-Chip for Storage Appliance 203 includes Storage Appliance 213 coupled to a plurality of disk arrays and providing connectivity via, e.g., Ethernet couplings. Each stippled double arrow indicates a FDX bidir connection at 224 GB/s that is enabled for trunking (aggregation). Each forward-slash patterned double arrow indicates a 10/40/100 GbE connection; there are four total. Each backward-slash patterned double arrow indicates a mass storage connection, including CXL; there are four total. Each instance of Server on-a-Chip 101 and each HRAM component each have 4 UHI ports.

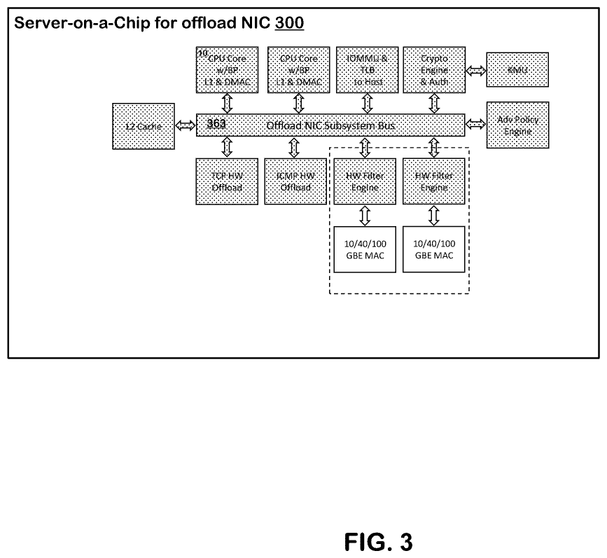

FIG. 3 illustrates various aspects of a Server-on-a-Chip directed to offload Network Interface Card (NIC) usage scenarios, as Server-on-a-Chip for Offload NIC 300. As in FIG. 1, stippled elements, e.g., Offload NIC Subsystem Bus 363 and elements coupled to it, indicate support for enhancements (such as backpressure) enabling improved performance. In certain variations, Offload NIC Subsystem Bus 363 is enabled to perform functions for cache-coherency, backpressure, and/or other operations to facilitate enhanced performance. In certain variations, Offload NIC Subsystem Bus 363 is similar to CPU-internal ccNUMA Switch Fabric UHPI 12. In certain variations, Server-on-a-Chip for Offload NIC 300 is a server-on-a-chip design, based, for example, on Server-on-a-Chip 100 of FIG. 1. Server-on-a-Chip for Offload NIC 300 is usable as an example of an offload NIC for a server-on-a-chip.

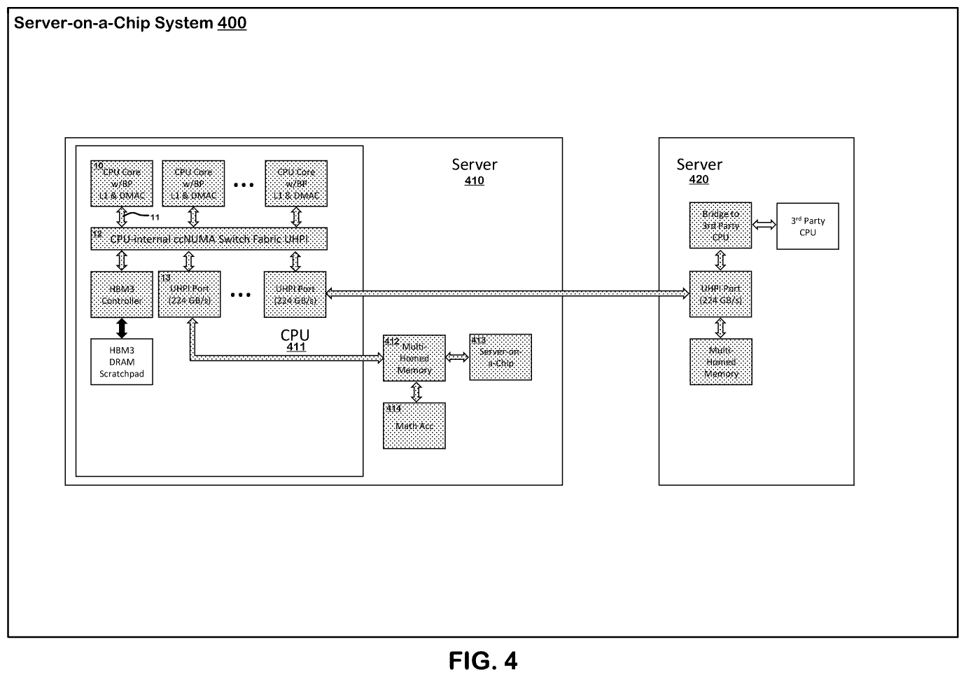

FIG. 4 illustrates various aspects of a Server-on-a-Chip system, as Server-on-a-Chip System 400. As in FIG. 1, stippled elements, e.g., CPU Core with BackPressure and L1 & DMAC 10, Coupling 11, CPU-internal ccNUMA Switch Fabric UHPI 12, UHPI Port 13, and so forth, indicate support for enhancements (such as backpressure) enabling improved performance. Server-on-a-Chip System 400 comprises Sever 410 and Server 420. In certain variations, CPU 411 and Server-on-a-Chip 413 of Sever 410 are respective instances of a same server-on-a-chip design, based, for example, on Server-on-a-Chip 100 of FIG. 1. In certain variations, CPU 411 is an instance of Server-on-a-Chip 100 and/or includes one or more elements similar or identical to those of Server-on-a-Chip 100 (such as CPU Core with BackPressure and L1 & DMAC 10, Coupling 11, CPU-internal ccNUMA Switch Fabric UHPI 12 and UHPI Port 13, as illustrated). In various server-on-a-chip systems, the UHPI Port of Server 420 is similar to or based on UHPI Port 13 of CPU 411 of Sever 410. In various server-on-a-chip systems, the Multi-Homed Memory of Server 420 is similar to or based on Multi-Homed Memory 412 of Sever 410. In various systems, the multi-homed memory has four universal ports each enabled to operate, e.g., via a switch fabric, with a respective CPU core. Server-on-a-Chip System 400 is usable as an example of a server-on-a-chip coupled to a 3^{rd} party server.

Multi-Homed Memory 412 is enabled to serve as a smart memory for a plurality of agents, e.g., any of the CPU Cores of CPU 411 and various agents of Server-on-a-Chip 413 (such as CPU, GPU, and/or Accelerator cores), as well as agents of Server 420 such as the 3^{rd} Party CPU. For example, Multi-Homed Memory 412 includes mapping resources (such as TLBs) for a plurality of agents. For another example, Multi-Homed Memory 412 includes backpressure resources for a plurality of agents. The UHPI ports (e.g., that enable coupling to the multi-homed memories) are agnostic with respect to types of memory supported by the multi-homed memories. For example, the UHPI ports operate according to a same protocol whether a target memory device is a DRAM, or an SRAM, or a phase-change memory, or any type of flash memory.

Math Accelerator 414 is enabled to perform various arithmetic, logical, and/or special-purpose functions more efficiently than Server-on-a-Chip 413. The greater efficiency is reflected in any combination of higher throughput, reduced latency, reduced cost (e.g., area), and/or reduced power consumption, among other characteristics. Certain examples of Math Accelerator 414 include one or more elements similar to those of Server-on-a-Chip 100 of FIG. 1A (e.g., one or more instances of UHPI Port 13, CPU-internal ccNUMA Switch Fabric UHPI 12, and instruction processing elements akin to CPU Core with BackPressure and L1 & DMAC 10).

In various examples of server-on-a-chip systems, any combination of the stippled double arrows corresponds to full duplex (e.g., bidirectional) communication channels with, e.g., respective bandwidths of 224 GB/s.

In various examples of server-on-a-chip systems, one or more of the communication channels are usable in aggregated and/or trunked configurations, enabling larger bandwidths. In certain example server-on-a-chip systems, communication between the HBM3 Controller and the HBM3 DRAM Scratchpad (indicated by the dark double arrow therebetween) exceeds 2 TB/s.

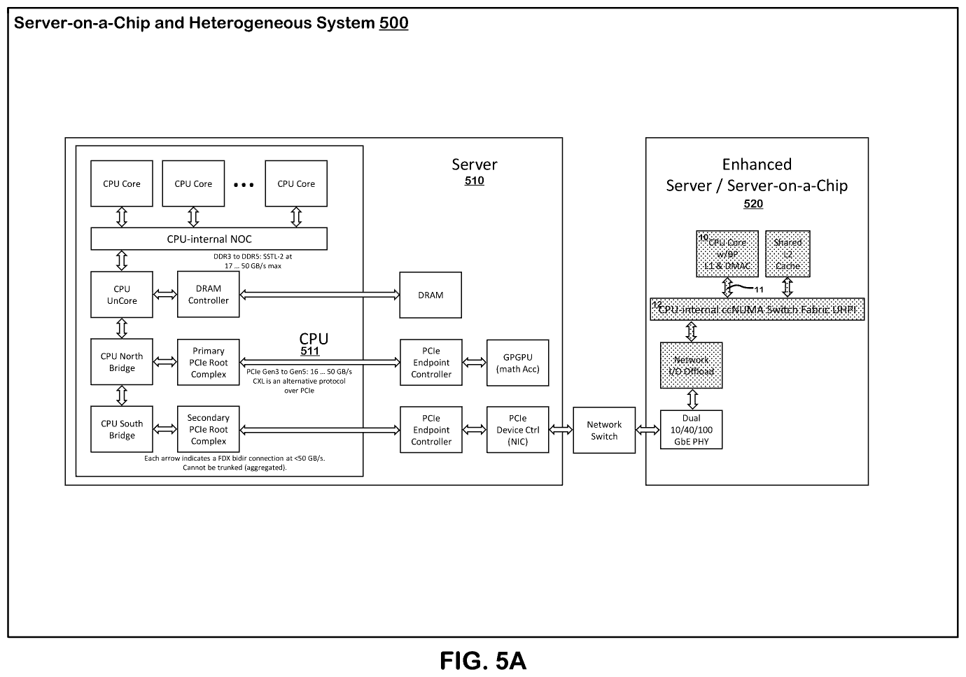

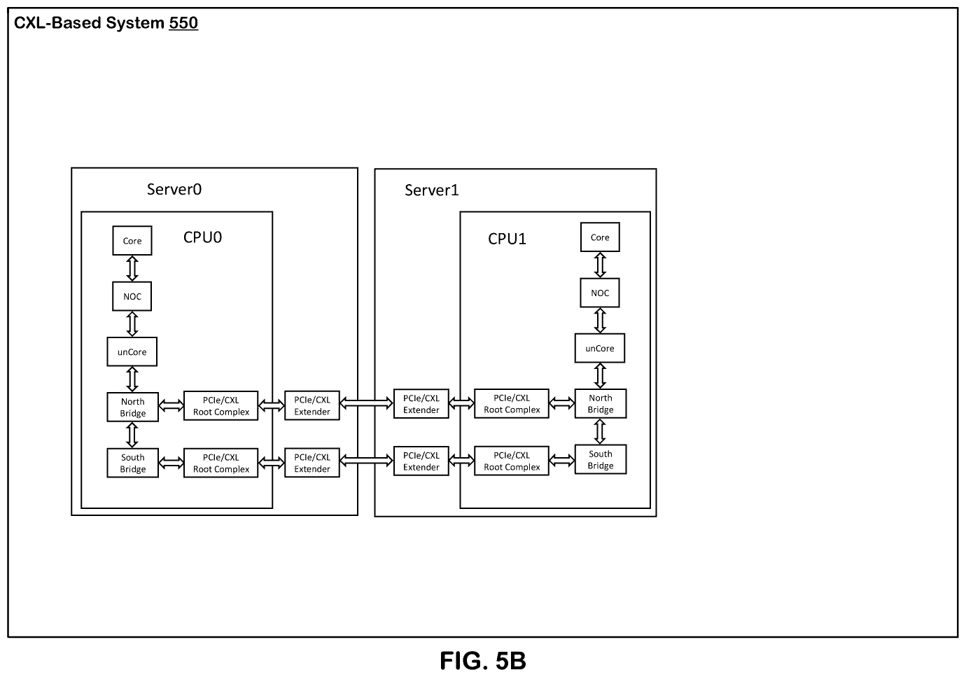

FIG. 5A illustrates various aspects of a Server-on-a-Chip heterogeneous system, as Server-on-a-Chip and Heterogenous System 500. As in FIG. 1, stippled elements, e.g., CPU Core with BackPressure and L1 & DMAC 10, CPU-internal ccNUMA Switch Fabric UHPI 12, and so forth, indicate support for enhancements (such as backpressure) enabling improved performance. The system is heterogeneous in that Enhanced Server/Server-on-a-Chip 520 includes support for enhancements (such as backpressure) that enable improved performance, but Server 510 lacks the support. The servers are enabled to interoperate, as follows.

Server-on-a-Chip and Heterogenous System 500 comprises Server 510 and Enhanced Server/Server-on-a-Chip 520. Server 510 couples CPU cores to the network switch via the CPU-internal NOC, the CPU UnCore, the CPU South Bridge, the Secondary PCIe Root Complex, the PCIe Endpoint Controller, and the PCIe Device Controller (NIC). Enhanced Server/Server-on-a-Chip 520 couples CPU Cores (e.g., CPU Core with BackPressure and L1 & DMAC 10) to the Network Switch via CPU-internal ccNUMA Switch Fabric UHPI 12, the Network I/O Offload module, and the Dual 10/41/100 GbE PHY interface. Thus, the CPU cores of Server 510 are enabled to communicate via CPU Core with BackPressure and L1 & DMAC 10 of Enhanced Server/Server-on-a-Chip 520 via standard HPC communication techniques.

In certain example heterogeneous systems, Enhanced Server/Server-on-a-Chip 520 corresponds to an instance of Server-on-a-Chip 100 of FIG. 1. Server-on-a-Chip and Heterogenous System 500 is usable as an example of a standard server coupled to a server based on a server-on-a-chip.

FIG. 5B illustrates various aspects of a CXL-Based System as CXL-Based System 550. Server0 and Server1 communicate according to a CXL communications stack. In the figure, each arrow indicates a FDX bidir connection at 16 to 25 GB/s. In this context, CXL is reusing the PCIe infrastructure, and as such incurs the same latency and bandwidth restrictions that PCIe does. In addition, a memory and a coherency protocol is implemented via CXL to enable memory operations over Peripheral Component Interconnect express.

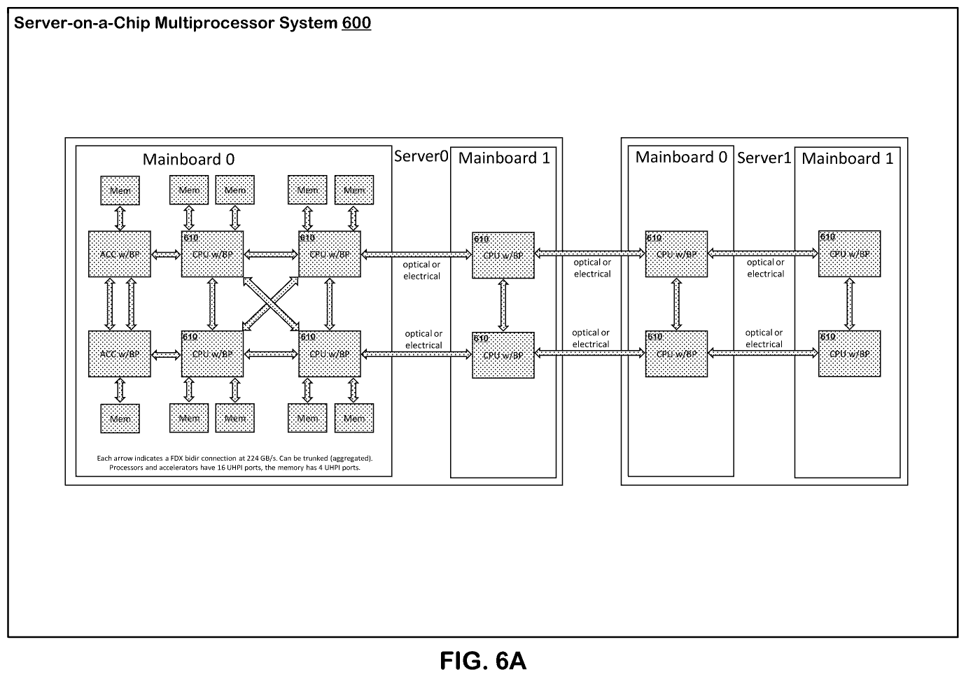

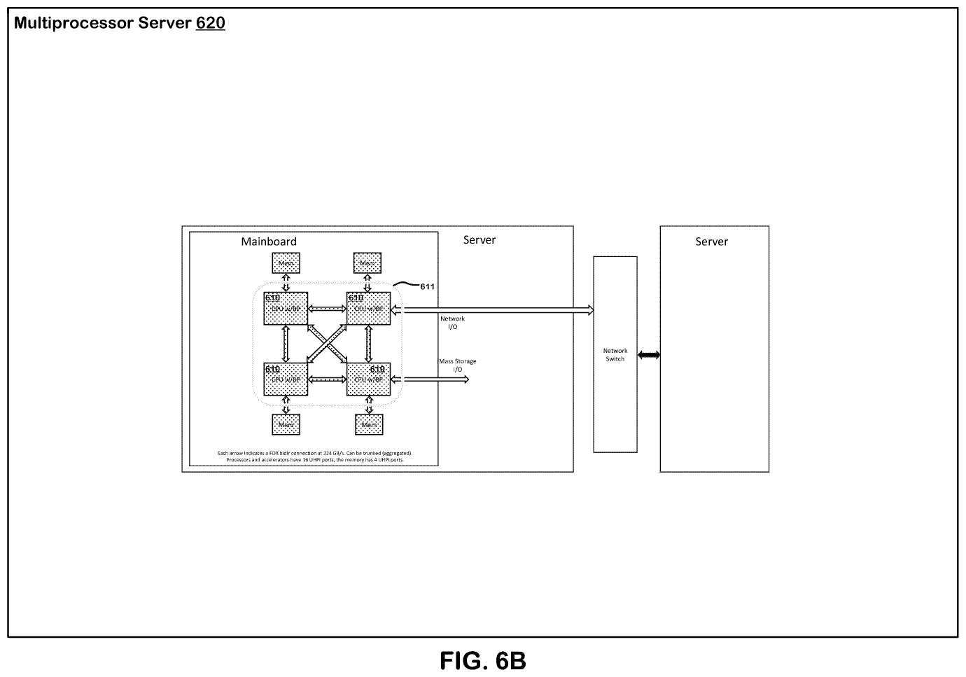

FIG. 6A illustrates various aspects of a Server-on-a-Chip multiprocessor system, as Server-on-a-Chip Multiprocessor System 600. As in FIG. 1, stippled elements indicate support for enhancements (such as backpressure) enabling improved performance. Server-on-a-Chip Multiprocessor System 600 comprises two servers, each illustrated according to a different level of detail. In various server-on-a-chip multiprocessor systems, the two servers are identical, substantially similar, or different according to one or more parameters, e.g., number of instances of server-on-a-chip elements. Each server comprises two Mainboards (Mainboard 0 and Mainboard 1). One or more optical or electrical couplings (illustrated as pairs of couplings) couple the mainboards to each other. In various examples, UHPI ports of server-on-a-chip elements of the Mainboards terminate the optical or electrical couplings. In certain examples, each of the Mainboards are identical and various internal details are omitted for clarity. In certain examples, each of the instances of CPU with BackPressure 610 are respective instances of identical or substantially similar designs. In certain examples, one or more of the instances of CPU with BackPressure 610 are different than others of the instances of CPU with BackPressure 610 (e.g., having more or fewer CPU cores or other elements).

In certain examples of instances of CPU with BackPressure 610, there are six UHPI ports, enabling connectivity between a plurality of those elements, as well as memory elements, as illustrated in the figure. Certain instances of CPU with BackPressure 610 are similar to Server-on-a-Chip 100 of FIG. 1, e.g., including elements corresponding to CPU Core with BackPressure and L1 & DMAC 10, Coupling 11, CPU-internal ccNUMA Switch Fabric UHPI 12, and UHPI Port 13. Server-on-a-Chip Multiprocessor System 600 is usable as an example of a heterogeneous multiprocessor system based on a server-on-a-chip with an accelerator connected to another similar server.

FIG. 6B illustrates various aspects of a multiprocessor system, as Multiprocessor server 620. As in FIG. 1, stippled elements indicate support for enhancements (such as backpressure) enabling improved performance. Multiprocessor server 620 includes two servers, each illustrated according to a different level of detail. In various server-on-a-chip multiprocessor systems, the two servers are identical, substantially similar, or different according to one or more parameters, e.g., number of instances of server-on-a-chip elements.

In some usage scenarios, Processors 611 provide 3.6 to 3.8 times the performance of a single instance of Certain instances of CPU with BackPressure 610. As nearest neighbor and/or FEA/FEM operations increase as a fraction of total work in an application, scale-out approaches linear scaling.

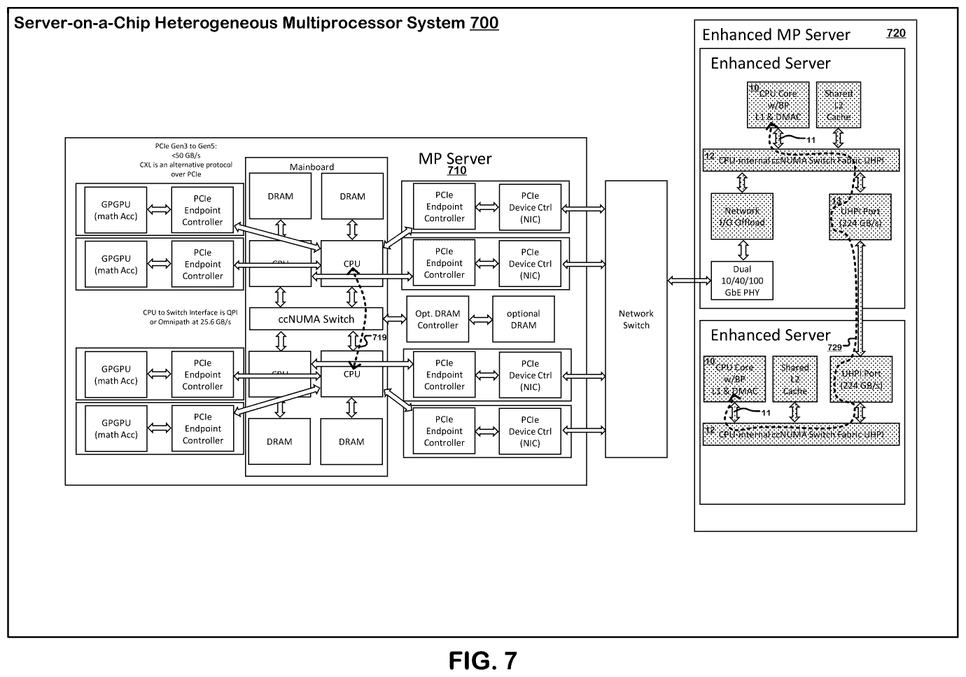

FIG. 7 illustrates various aspects of a Server-on-a-Chip heterogeneous multiprocessor system, as Server-on-a-Chip Heterogeneous Multiprocessor System 700. As in FIG. 1, stippled elements, e.g., CPU Core with BackPressure and L1 & DMAC 10, CPU-internal ccNUMA Switch Fabric UHPI 12, and so forth, indicate support for enhancements (such as backpressure) enabling improved performance. The system is heterogeneous in that Enhanced MP Server 720 includes support for enhancements (such as backpressure) that enable improved performance, but MP Server 710 lacks the support. The network switch enables the servers to communicate with each other.

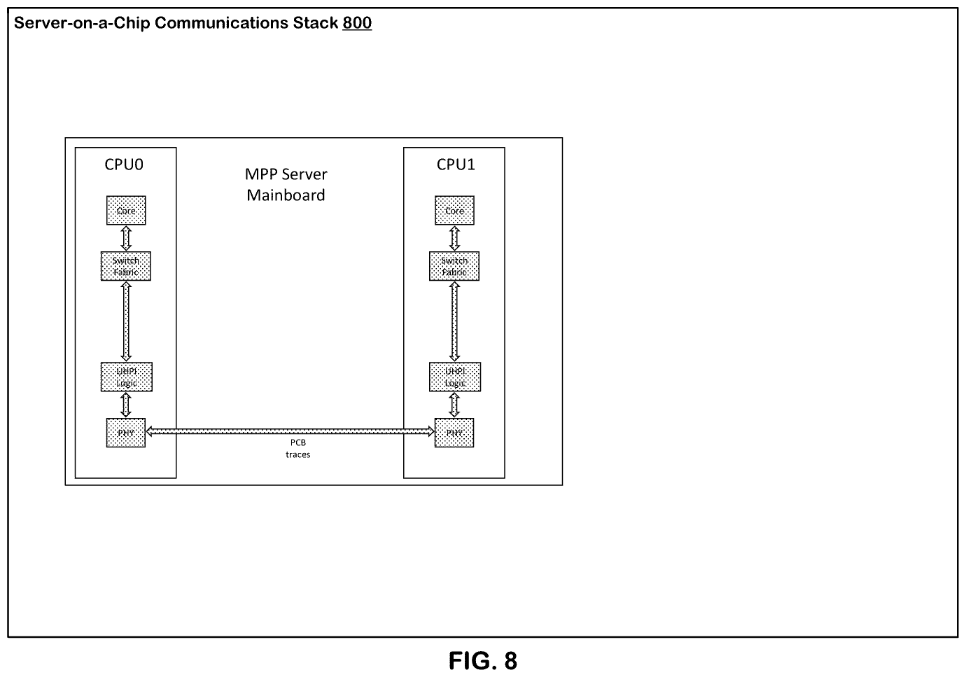

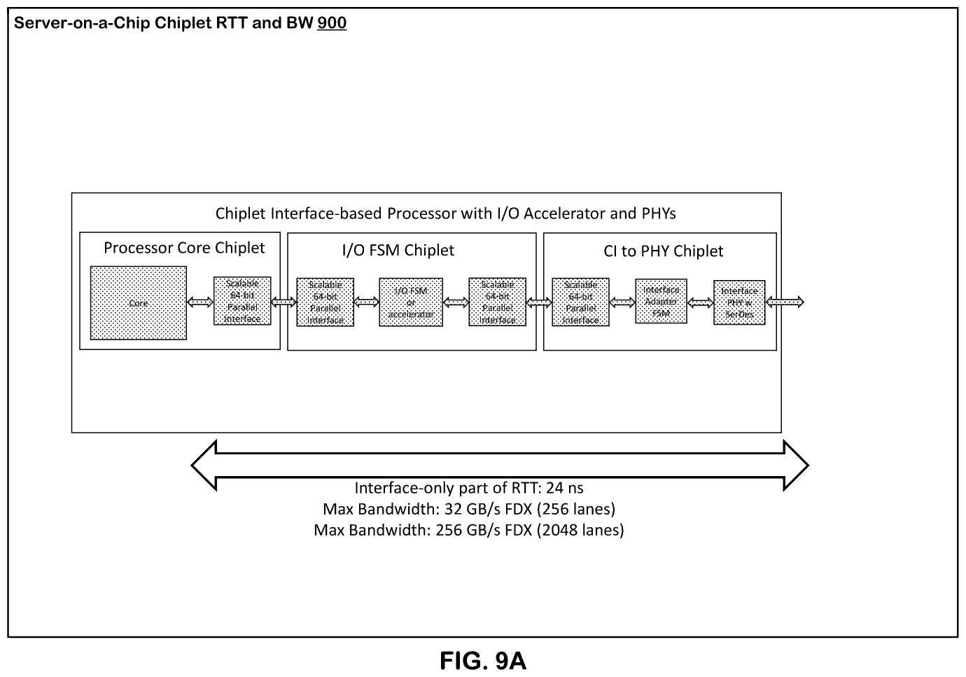

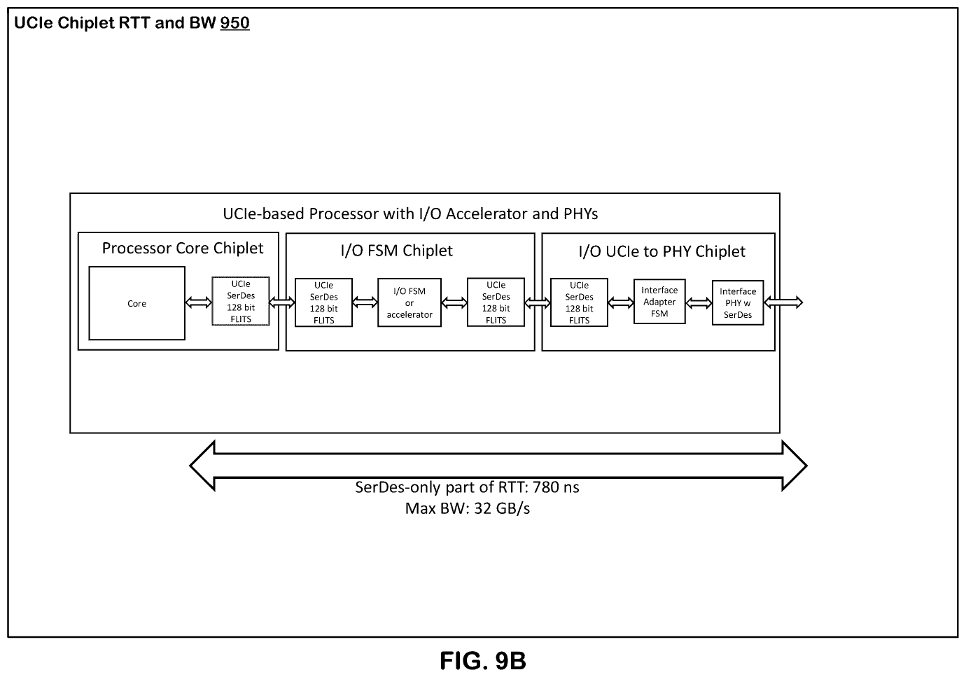

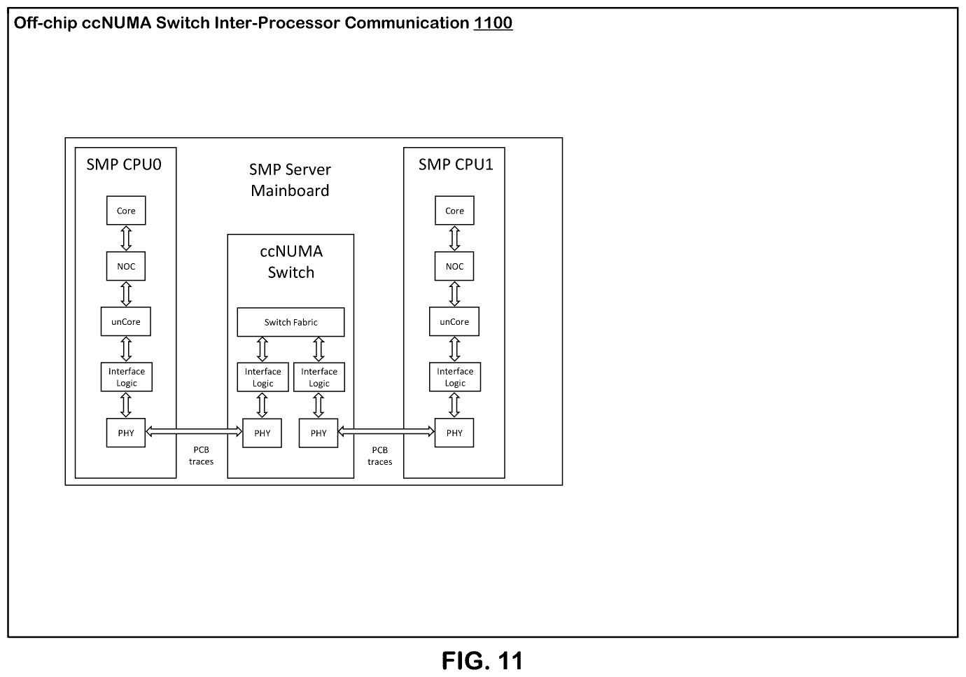

Server-on-a-Chip Heterogeneous Multiprocessor System 700 comprises MP Server 710 and Enhanced MP Server 720. MP Server 710 couples CPUs to each other via the ccNUMA switch of the Mainboard, as illustrated by Off-chip ccNUMA Switch Inter-Processor Communication 719. Further description of Off-chip ccNUMA Switch Inter-Processor Communication 719 is provided via FIG. 11, as well as paragraphs describing same. Enhanced MP Server 720 couples CPU Cores to each other via CPU-internal ccNUMA Switch Fabric UHPI 12 and other elements, as indicated by dashed double arrow Server-on-a-Chip ccNUMA Switch Fabric Inter-Processor Communication 729. Further description of Server-on-a-Chip ccNUMA Switch Fabric Inter-Processor Communication 729 is provided via FIGS. 8-9, as well as paragraphs describing same.

In various examples, the Enhanced Servers are instantiations of a same design.

FIG. 8 illustrates various aspects of a Server-on-a-Chip communications stack, as Server-on-a-Chip Communications Stack 800. As one example, specifically with respect to FIG. 7, each of the Cores corresponds to an instance of CPU Core with BackPressure and L1 & DMAC 10. Each of the Switch Fabrics corresponds to an instance of CPU-internal ccNUMA Switch Fabric UHPI 12. Each of the instances of UHPI Logic and the PHY element coupled to it represent an instance of UHPI Port 13. Thus, the path from the Core of CPU0 to the Core of CPU1 corresponds to Server-on-a-Chip ccNUMA Switch Fabric Inter-Processor Communication 729 of FIG. 7.

FIG. 8 is simplified for clarity. Various examples of the communications stack include operation with processor and/or accelerator components having 16 UHPI ports each and memory components having four UHPI ports each. Thus, for example, there are eight components along the path from any core to any other core across two processors, including the cores themselves. Thus, for another example, an external ccNUMA switch is not necessary for board-to-board connections, as the 16 UHPI ports provide sufficient connectivity (e.g., as illustrated by Server-on-a-Chip ccNUMA Switch Fabric Inter-Processor Communication 729 of FIG. 7).

In certain variations, any combination of the stippled double arrows corresponds to full duplex (e.g., bidirectional) communication channels with, e.g., respective bandwidths of 224 GB/s. In various examples, one or more of the communication channels are usable in aggregated and/or trunked configurations, enabling larger bandwidths.

FIG. 9A illustrates various aspects of Server-on-a-Chip chiplet-based interface round trip time and bandwidth, as Server-on-a-Chip Chiplet RTT and BW 900. The figure represents another view of (one half of) the communications stack of FIG. 8 and the portions of Server-on-a-Chip ccNUMA Switch Fabric Inter-Processor Communication 729 of FIG. 7 from each instance of CPU Core with BackPressure and L1 & DMAC 10 to the chip boundary of each of the Enhanced Servers. FIG. 9 illustrates a portion of a single processor as three chiplets, such as packaged in an MCM.

An example RTT is calculated as follows. Assume a 2 GHz Core clock frequency and a 1 GHz clock chiplet interface frequency. Assume two address phases, one command word phase, and one (wider) data phase for the Scalable 64-bit Parallel Interface. The latency is Ins*3=3 ns per interface, resulting in a total RTT of 24 ns. This result is applicable, e.g., to communications between CPU and Accelerator cores in different MCMs.

An example BW is calculated as follows. Assume identical parameters as the example RTT calculation. Further assume the data phase uses 256 lanes per direction (512 connections corresponding to 512 bumps on each chiplet). Further assume the communication is full-duplex and 1 GT/s at 32 bytes per transaction, resulting in an example BW of 32 GB/s.

Another example BW is calculated as follows. Assume identical parameters as the example RTT calculations. Further assume the data phase uses 2048 lanes per direction (4096 connections corresponding to 4096 bumps on each chiplet). Further assume the communication is full-duplex and 1 GT/s at 256 bytes per transaction, resulting in an example BW of 256 GB/s.

FIG. 9B illustrates various aspects of Server-on-a-Chip UCIe chiplet-based interface round trip time. An example RTT is calculated as follows. Assume a 4 GHz core frequency, a 4 GHz symbol frequency using a UCIe SerDes with 128/130 encoding, 128-bit FLITS, and two address and one command Word Phases. An example per SerDes latency is 130*0.25 ns*3=97.5 ns. There are four SerDes in each of the forward and the return paths, thus an example RTT (SerDes only) is 780 ns.

An example BW is calculated as follows. Assume identical parameters as the example RTT calculation. Further assume the data phase uses 64 lane pairs per direction (256 connections corresponding to 256 bumps on each chiplet). Further assume the communication is full-duplex and 4 GT/s at 8 bytes per transaction, resulting in an example BW of 32 GB/s.

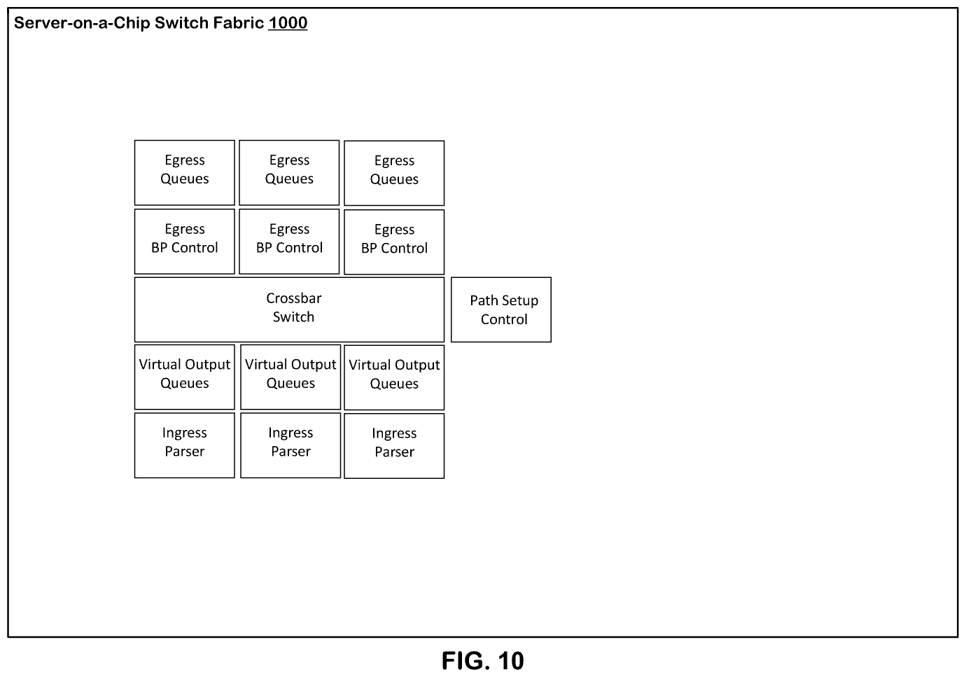

FIG. 10 illustrates various aspects of a Server-on-a-Chip Switch Fabric, as Server-on-a-Chip Switch Fabric 1000. Server-on-a-Chip Switch Fabric 1000 comprises a Crossbar Switch enabled by a Path Setup Control module to configure the switch fabric for ingress to egress communication channels. Ports of the switch fabric optionally include a backpressure indicator and/or a status indicator as dedicated signals.

A plurality of Ingress Parser modules manages a plurality of Virtual Output Queues (e.g., to reduce head-of-line blocking). Each Virtual Output Queue is enabled to store a number of transactions in a corresponding number of entries of the Virtual Output Queue. Each Virtual Output Queue corresponds to a physical (input) port of the switch fabric and is managed with respect to output ports of the switch fabric. The Ingress Parser modules process incoming transactions and determine various attributes of the transactions, such as type, source, target, and priority from respective transaction headers of the transactions. The transaction headers optionally include backpressure information and/or one or more status indicators.

A plurality of Egress BP Control modules monitors a plurality of Egress Queues. Each Egress Queue is enabled to store a number of transactions in a corresponding number of entries of the Egress Queue. Each Egress Queue corresponds to a physical (output) port of the switch fabric.

The Egress BP Control modules monitor how many entries are used in each of the Egress Queues. Responsive to an Egress Queue reaching a high watermark number of used entries (e.g., when 50% full), the Egress BP Control module monitoring the Egress Queue indicates backpressure to all agents sourcing information to the switch fabric destined to the Egress Queue.

In response, the sourcing agents block sending information to the switch fabric. The blocking is optionally non-selective, e.g., all transactions of all types and destinations are blocked. The blocking is optionally selective according to transaction type (e.g., read versus write versus probe) and/or transaction destination.

Responsive to the Egress Queue reaching a lower watermark number of entries (e.g., when 25% full), the Egress BP Control module monitoring the Egress Queue indicates release of the backpressure to all the agents sourcing information to the switch fabric destined to the Egress Queue. In response, the sourcing agents cease blocking transactions (either selectively according to destination or non-selectively according to design or usage scenario).

Various CPU-internal ccNUMA switch fabrics are implementable in accordance with Server-on-a-Chip Switch Fabric 1000. For example, CPU-internal ccNUMA Switch Fabric UHPI 12 is implementable in accordance with Server-on-a-Chip Switch Fabric 1000, such as to provide backpressure signaling to agents coupled thereto (e.g., CPU Core with BackPressure and L1 & DMAC 10 and UHPI Port 13, as well as the HBM3 Controller and so forth). Various subsystem bus elements are implementable wholly or partially in accordance with Server-on-a-Chip Switch Fabric 1000, such as to provide backpressure signaling (e.g., Mass Storage Subsystem Bus 263 of FIG. 2A and/or Offload NIC Subsystem Bus 363 of FIG. 3).

FIG. 11 illustrates various aspects of inter-processor communication using an off-chip ccNUMA switch, as Off-chip ccNUMA Switch Inter-Processor Communication 1100. As one example, specifically with respect to FIG. 7, each of the Cores corresponds to an instance of one of the CPUs of FIG. 7. The ccNUMA switch corresponds to the ccNUMA Switch of FIG. 7. Thus, the path from the Core of SMP CPU0 to the Core of SMP CPU1 corresponds to Off-chip ccNUMA Switch Inter-Processor Communication 719 of FIG. 7.

Couplings between elements are full-duplex (bidirectional) providing BWs of 16-25 GB/s. There are several encoding/decoding, forward error correcting, and SerDes operations, each with a respective latency. A transaction from one to another of the Cores traverses 15 components each way.

FIG. 12 illustrates various aspects of a Server-on-a-Chip boot flow. The following description of the boot flow refers to various elements of FIG. 1. The boot flow uses smart memory capabilities, such as collectively provided by the HBM3 controller, the DRAM Controller Cluster, and CPU-internal ccNUMA Switch Fabric UHPI 12 of FIG. 1. The smart memory capabilities include IOMMU, DMA, and cryptographic functions. For example, the Memory TLB element of FIG. 1A provides IOMMU functions. For another example, the DRAM Controller Cluster includes a DMAC module to provide DMA functions. For another example, the KMU module of FIG. 1A provides for cryptographic key storage and/or cryptographic encryption/decryption functions. In various example systems, cryptographic information in the KMU module is inaccessible to the CPU Cores of Server-on-a-Chip 100.

The boot flow begins when a server is powered-on, illustrated as Power On 1201. Then physical memory is sized and mapped contiguously using smart memory functionality, as follows. A controller portion of the DRAM Controller Cluster, in conjunction with the Memory TLB element, probes one or more physical memory portions of memory accessible via the DRAM Controller Cluster (e.g., implemented as one or more DRAM chiplets) to determine sizes of the DRAM chiplets. The controller portion programs entries of the TLB portion of the Memory TLB element so that the physical memory portions appear as one contiguous memory to agents accessing the physical memory. The sizing and contiguous mapping is illustrated as Locally Size DRAM and Map Contiguously 1202.

Then a boot image is locally decrypted to a portion of the physical memory using further smart memory functionality, as follows. The controller portion (of the DRAM Controller Cluster), in conjunction with the Memory TLB element and the KMU element, verifies (using one or more cryptographic functions) that key material stored in KMU matches what is computed from one of one or more boot images stored in Boot Resource 150. The controller then decrypts the verified boot image into a portion of the physical memory. Note that the verifying and the decrypting are performed without assistance from other agents coupled to CPU-internal ccNUMA Switch Fabric UHPI 12. The local decrypting is illustrated as Locally Decrypt Boot Image to DRAM 1203.

Then the controller enables accesses from the agent coupled to a specific port (e.g., Port 0) of CPU-internal ccNUMA Switch Fabric UHPI 12, illustrated as Enable Accesses from CPU(s) 1204. Subsequently, the agent coupled to Port 0 (e.g., an instance of CPU Core with BackPressure and L1 & DMAC 10) allocates the physical memory among various agents coupled to CPU-internal ccNUMA Switch Fabric UHPI 12 (e.g., itself and other instances of CPU Core with BackPressure and L1 & DMAC 10) into one or more contiguous blocks of exclusive and shared memory. For example, one contiguous block is allocated to itself exclusively, another contiguous block is allocated exclusively to a second instance of CPU Core with BackPressure and L1 & DMAC 10, and a third contiguous block is allocated as shared between itself and the second instance. The controller uses one or more entries in the TLB portion (of the Memory and TLB element) to store and implement the allocations of the physical memory. Then the agent coupled to Port 0 enables other CPU cores to execute (such as to boot from the decrypted boot image), as illustrated by All CPU(s) Running 1205.

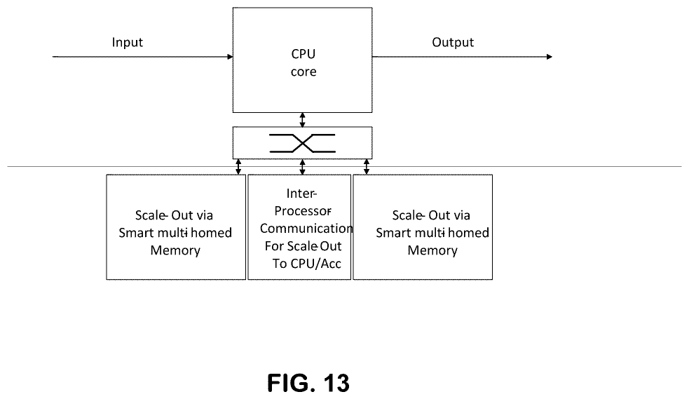

FIG. 13 illustrates various aspects of a system using a Server-on-a-Chip.

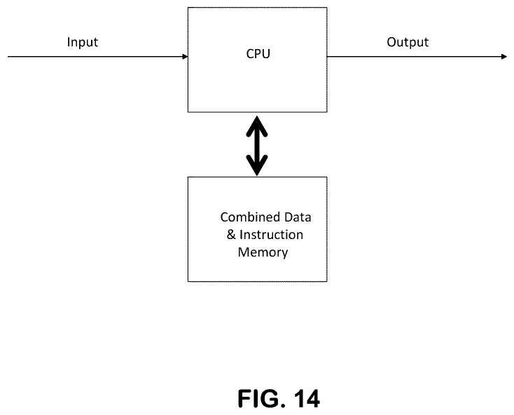

FIG. 14 illustrates various aspects of Princeton (von Neumann) architecture. Note that communication between elements is limited.

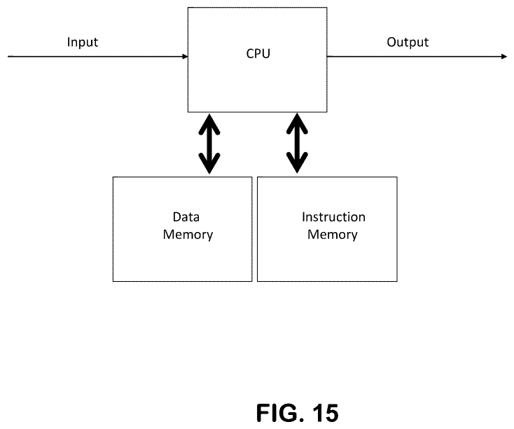

FIG. 15 illustrates various aspects of a Harvard architecture. Note that communication between elements is limited.

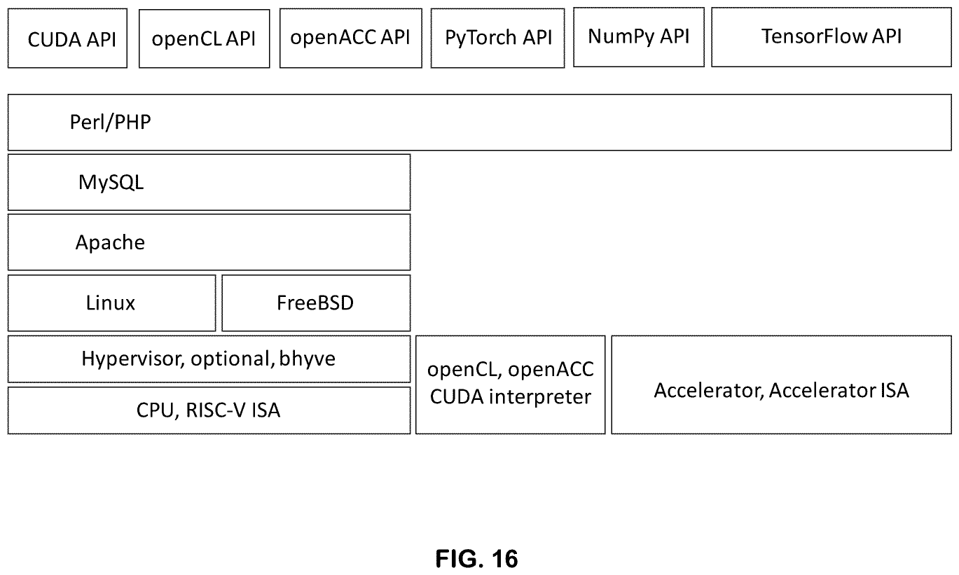

FIG. 16 illustrates various aspects of software and Application Programming Interface (API) elements for a system using a Server-on-a-Chip and/or a supercomputer server, such as illustrated in any of FIGS. 1A, 1B, 2A, 2B, 2C, 3, 4, 5A, 6A, 6B, 7, and 8.

### Rack and Server Concepts

In some implementations, there is one server per rack. Links between servers, such as a closest pair each on a respective mainboard, transition across folded sheet metal between the servers of the pair.

In some implementations, there are two servers per rack, e.g., one server per one-half rack. Links between at least a closest pair of servers (such as a pair of servers each on a respective mainboard, the pair of servers occupying one rack) transition from one server of the pair the other server of the pair without transitioning through folded sheet metal, enabling lower-cost and/or high performance optical interconnection between the servers of the pair (compared to one server per full rack). Conceptually, 2D interconnect becomes 2.5D interconnect. In some implementations having one server per half rack, compared to one server per full rack, there are fewer individual power supplies, less folded sheet metal, better cooling, and/or higher total performance. In some implementations having one server per half rack there is no top-of-the-rack switch used.

In some implementations, e.g., some implementations having two servers per rack, improved physical proximity of compute nodes and storage nodes is enabled by using the bottom half rack as storage and the top half rack as compute.

### Supercomputer Server Architecture: CXL

CXL is a secondary protocol over the PCIe infrastructure, intended to enable memory disaggregation from a server and its processors. However, PCIe is a high-latency infrastructure, and thus is not suited to memory attachment.

If CXL is used to replace non-shared SATA Flash, then it can be made to work as CXL still has lower latency than a SATA- or SAS-attached disk, even an SSD. The problem arises when that CXL-attached memory is shared. If it is shared, then a coherency mechanism must be present to ensure that shared data has not been invalidated by a prior write access coming from a different processor. To ensure coherency, mechanisms such as MESI, MOESI and directory-based approaches exist, but all of them rely on a lookup for validity first. In other words, before a data set is read, a read access to a directory or the MESI/MOESI bits for that data set is needed to check if it is still valid, or if it has become invalid due to a modification from another processor which had fetched that data set but had not had the time to write back the modified data. If the data is still valid, then a read access can be executed while locking that data set copy in the shared CXL-attached memory to other accesses from other processors. The more processors (including the many cores in current processors) have access to this shared memory, the higher the percentage of time during which the data set is not accessible, invalid, or locked. Since CXL is such a high-latency infrastructure, the metadata traffic, and the lockout times due to the long round-trip times will be a significant portion of the memory access times, and the usefulness of CXL-attached memory is reduced. In other words, sharing memory over a high-latency infrastructure such as CXL does not solve the problem; it will instead create new ones. It will be even more exacerbated if the memory is shared in an appliance that includes internal CXL switches.

CXL is another protocol on top of PCIe and thus has the same latency problems. CXL effectively can only carry non-coherent memory traffic.

Why is latency such an issue? As a simplification, this is what happens if a CPU (or more precisely, the processor core and its L1/L2/L3 cache) cannot access memory contents that it needs to continue working. It needs to stall, switch tasks, or go to sleep. In either case, no work gets done, unless a task switch is possible with context saved to cache and context from another thread being retrieved from cache without using DRAM. All data fetches cost energy, but task switches by themselves are not executing user code. The CPU can only continue to execute user code if in fact a context switch is possible with valid data already present in one of its caches. The higher the latency to and from DRAM, the larger the caches have to be, and the more hierarchies of caches have to be present in a processor. Large caches with their TCAMs and all external inefficient I/O such as SSTL-2 are the biggest power hogs. In other words, large shared contended and blocking DRAM accessible through a high-latency infrastructure such as PCIe and CXL enforce an ever-growing need for more caches.

Supercomputer Server Architecture: Big and Slow is Faster than Small and Fast

In some usage scenarios, big and slow is in fact faster than small and fast.

Why is that the case? The reason is the enormous discrepancy between the throughput of a processor compared to DRAM, and DRAM bandwidth and latency compared to Flash memory. Processors today crunch through data incredibly quickly. SRAM caches are used to hide the DRAM latency. If the processor cannot find the data in its cache, it will try to retrieve it from DRAM. It will take a penalty of many cycles to do so. If the data is not in DRAM, then it had been swapped out to disk in the past, and now the processor has to wait even longer as accessing a disk is slow. Therefore, it makes sense to avoid having to access disks altogether. That is not possible yet as disks are dense and cheap but reducing the frequency at which a processor has to access disks enhances performance. Therefore, exchanging expensive DRAM with cheap and slow (but still faster than disk) and much larger Flash memory makes sense.

For Big Data, more memory means that the processors access disks less often than with faster but smaller DRAM memories.

### Supercomputer Server Architecture: HPC Evolution and the Case for a New Paradigm

In the last decade, the need for High Performance Computing (HPC) and other large-scale applications such as the entire Internet backend, the introduction and phenomenal rise of cloud computing (public, private and hybrid) has created the hyperscalers and upended the traditional way that data centers were built. The servers that are at the core of those data centers now have to deal with applications, data sets and data handling needs as well as sheer size that they were never designed to crunch. The advent of large data set applications (Big Data, AI, Machine Learning, traditional HPC) has only aggravated the problem. As a result, it is critical to understand that traditional supercomputer and scale-out paradigms no longer work well in the data center. A novel approach to balancing computation (including accelerators for special-purpose applications), data movement and storage is required.

Supercomputers resemble commercially off the shelf (COTS) servers that are interconnected via low-latency InfiniBand or standard Ethernet LAN (currently between 10 Gbit/s and 400 Gbit/s) with low-latency top-of-the-rack switches. They are large clusters of identical servers based on the x86-64 or ARM processor architectures, with low-latency InfiniBand or Ethernet switches to interconnect those servers. Supercomputers optionally include accelerators in addition to general-purpose COTS server processors.

These supercomputers are related to the hyperscalers' data centers in terms of the type of server that is deployed. Virtualization and progress in programming languages as well as in compilers have made the choice of CPU instruction set architecture (ISA) less relevant than ever. The benefit of using COTS servers, switches and storage arrays has reduced the cost of a supercomputer vastly, from $100M for a Cray Y-MP to about $500,000 for the minimum performance of such a machine that would still qualify as a supercomputer today.

The problem that the industry is facing today is manifold and having to do with the advances in processor design, chip manufacturing (or fabricating/fabbing), and with the application profile of supercomputers versus the hyperscalers in their data centers. The problem today does not lie in the CPU cores, it is in the “speed limit” in all units and components and interfaces around them. PCIe tops out at about 16 GB/s. A 100 Gbit/s NIC does not transport more than 10 GB/s. The interconnect between the CPU and the rest of the system is proprietary and usually does not manage more than 200 GB/s. A DDR5 memory channel tops out at around 30 GB/s in burst mode. To achieve 1 ExaFLOPS, at least two operands and one instruction are transferred in, and one result is transferred out, at a rate of 1 trillion per second. Depending on the word size this can be 32 bits, 64 bits, 80 bits for 8087-compatible floating-point, or 128 bits. Thus, up to 256 bits of operands plus one instruction word at 64 bits in, and one operand out are transferred per cycle. That is 9 bytes per operand, or 9 trillion bytes per second in and out. Even if scaled out over many processors and (GPGPU) accelerators, which is a relatively large internal and external bandwidth the supercomputer has to provide.

Supercomputing is usually referred to as solving large monolithic problems quickly. Hyperscalers on the other hand run hundreds of thousands of applications on tens to hundreds of thousands of servers in one data center, with optional replication across data centers.

Therefore, the application profiles and thus the required hardware are different for hyperscalers and supercomputers.

Two items are not scaling in performance: memory, specifically DRAM, and the processor-to-anything interconnect. Caching reduces the lack of scaling, but no compute occurs in caches.

Some processors are designed such that the on-die cores are connected via a bus, and that bus also connects the cores (or core arrays) to the outside world. The problem with that is that a bus is blocking (e.g., if core0 communicates with core1, then core2 cannot communicate with anything else), and a bus (and some switch fabrics) are contending (e.g., if a core is communicating with DRAM, then another core cannot communicate with DRAM at the same time). The internal bus and access to any external I/O, including memory and other processors or accelerators, become the bottlenecks and require larger caches and more hierarchy levels of it to keep the cores busy and avoid stalling them.

Low-latency switch fabrics and crossbars that are inherently non-blocking or blocking-free enable various performance improvements. The switch fabrics of the supercomputer servers are additionally capable of reducing contention, and the UHPI ports reside on one switch port. As a result, any core in any processor can communicate with any other core while any of the other combinations can communicate. For n cores, there can be n/2 simultaneous connections in the supercomputer system. For 256 cores, 128 full-duplex bidirectional internal cases of inter-processor-communication can take place simultaneously, whereas in a legacy processor using an internal bus only one is allowed concurrently at any time.

The internal switch enables all cores to communicate with 16 target memories at the same time, whether they are on the same UHPI Port or on 16 different ones. Thus, the size and the number of levels of hierarchy of caches in the processors is reduced, so caches use up less space and energy in the supercomputer processors.

For the Server-on-a-Chip a set number of processor cores are dedicated to mass storage (hard disk, SSD, NVMe, M.2 Flash) I/O, and another one to network I/O. This enables pre-processing and filtering of network I/O, including running a firewall, and make use of storage protocols such as RAID and ZFS to enhance mass storage I/O without putting a burden on the application processor cores. These I/O offload engines run a real-time operating system that reduces latency over using a full-featured multi-user, multi-tasking OS such as Linux while at the same time providing the same benefits at a lower level of energy consumption. The cores are optimized to their intended purpose and include DMA/IOMMU functions at a lower level of complexity. The same is true for an on-chip Baseboard Management Controller that allows for secure remote management of the Server-on-a-Chip while providing full security, e.g., via resilient secure boot and/or assured firmware integrity by using authentication and encrypted firmware. This chip can be used as a single-chip server, or in conjunction with other processors, as an I/O frontend for supercomputers of a new generation. Unlike current processors that provide a total of around 250 GB/s for communication with DRAM and another processor of the same kind, this processor includes both the traditional DRAM interfaces so it can use legacy DRAM and UHPI capabilities, providing 224 GB/s of full-duplex bidirectional I/O at a pincount similar to QPI or OmniPath at 1/10 of that bandwidth.

For example, a database processor and a math processor both are combinations of hardware logic for certain special functions and fully programmable CPU cores. Both processors are pin-compatible and communicate with each other, the Server-on-a-Chip, and the intelligent memory subsystem through 16 UHPI ports, giving them a total I/O bandwidth of over 3.5 TB/s. This bandwidth can be allocated to inter-processor-communication, communication with main memory, which is the intelligent memory subsystem, or to and from a Server-on-a-Chip as an I/O frontend for mass storage and network I/O, or a combination thereof. The interface and protocol on UHPI are agnostic to the device.

This processor as an I/O frontend will relieve the supercomputer core from all necessary mass storage I/O and from all network I/O, including filtering and access control, for better performance and security. With this concept, compute and storage nodes can be separated or integrated (“hyper-converged’ or “ultra-converged”).

The second major item that creates a bottleneck is memory. Processor performance in the past 20 years grew by at least a factor of 1000. However, DRAM is still clocked at 200 to 233 MHz in its core, and as such memory bandwidth is limited. That limitation can be reduced by using wider memory, but the problem of latency remains. That can only be solved by using caching. The problem with that is that the CPU dice today are already big, they consume enormous amounts of energy, and the heat that is created has to be conducted away from the processor. As a result, using wider memory buses or more DRAM Controllers with larger caches on the processor dice is not necessarily beneficial. Further, much of the memory bandwidth (but not the size) is used for inter-processor-communication and therefore it is transient.

Partitioning the system so that the CPU or processor or accelerator does not include any DRAM Controllers enables modifying the system architecture by transferring the DRAM Controller onto an intelligent memory subsystem. One benefit is that the processors and accelerators do not need any memory controllers in such a scenario. At the same time, the memory controllers can be designed in a fashion that allows them to tailor themselves exactly to the DRAM (and possibly and optionally Flash) dice used in the intelligent memory subsystem. Since it can easily be made multi-homed, this opens up the possibility of smartly intercepting and identifying traffic that is intended to be used for data exchange between processors, for semaphores, or for other data such as cache validity messages that are transient in nature, and therefore do not need to be stored in DRAM, instead just keeping these datagrams in SRAM. As a result, the intelligent memory subsystem can contribute to more linear scaling across processors, and as a result, will support large-scale deployments of processor and accelerator cores. This contrasts with the way that shared memory today is implemented, and instead of reducing the performance of shared memory, it increases it. The new memory subsystem does not increase cost over DIMMs while retaining a drastic performance advantage over even quad-channel DDR5. With the reduction in pincount of the UHPI over DDR5, particularly if compared against a quad-channel design, there is no more need for traditional and legacy DRAM on DIMMs.

A heterogeneous RAM includes multiple hierarchies of memory and the associated memory controllers. It is a 1 TB or 4 TB random access memory with integrated memory controllers and caches in a single package. Some versions connect to the supercomputer server processors via four full-duplex UHPI ports. The heterogeneous RAM features high bandwidth, high density, low latency, and enhanced features such as autonomous memcopy (zero thread) MemCopy, auto or on-demand scrubbing, advanced parity checking and error detection and correction abilities, and many others. These random access memories are optimized for massively multi-threaded, multi-core host processors, and associated workloads. They are multi-homed, e.g., they are enabled to connect to multiple processors. All address fields are 64-bit. 48 bits are used to future-proof the design for a total address space of 256 TB per heterogeneous RAM. Density, performance, and I/O and internal bandwidth are improved. In some variations, the heterogeneous RAM is an external and therefore extensible solution. Due to its nature of disassociating the memory controller from the CPU and the cores, and its intelligent parser and command interpreter, the heterogeneous RAM is not vulnerable to known attacks such as Rowhammer and Half-Double, or any other attacks that exploit the way that DRAM fundamentally works and is made. The heterogeneous RAM provides resilient secure boot from an attached SPI Flash, and it can function as the ultimate root of trust for a firmware update.

Together, the Server-on-a-Chip, the heterogeneous RAM, and the database and math processors enable implementation of a modern server that constitutes the core for a supercomputer for traditional HPC workloads, or as the basic building blocks for hyperscalers in public, private or hybrid cloud environments, or as a scalable component for future data centers.

### Supercomputer Server Architecture: Interrupt Request (IRO) and Interrupt Service Routine (ISR)

### Preface

In any modern computer system events occur and are processed. Events are internal or external and have a range of criticality and priority as well as incidence rate. Oftentimes, high-priority and critical events are processed using an Interrupt Controller (a hardware component) and an Interrupt Service Routine (aka ISR, a software component). The Interrupt Controller receives Interrupt Requests through individual bit lines and signals, or through a messaging system, or a combination thereof. Multi-user and multi-tasking Operating Systems rely on a timer tick interrupt and Interrupt Controllers to function properly, and Real-Time Operating Systems need the timer tick interrupt as well as a Watchdog Timer and an Interrupt Controller. Very few components and OSes rely on polling.

Modern Peripheral Interconnect systems such as PCIe (Peripheral Component Interconnect express) use message-based Interrupt requests whereas older and simpler I/O or on-die I/O oftentimes uses individual bit lines for the assertion of an Interrupt Request. Most inter-processor communication (IPC) systems use message-based Interrupt requests, whereas most memory controllers use a single bit line for signaling the request for service. Accelerators, coprocessors, and many DMA Controllers will also be able to issue Interrupt Service Requests.

To facilitate Interrupt Request and Service needs, one or more Interrupt Controllers are needed, and Operating System support as well as support from the developer of the software drivers for I/O, peripherals, Accelerators, coprocessors, and DMA Controllers is required. Best practices and established technologies exist for x86-64, ARM, and RISC processor families as well as for all Operating Systems such as Linux, FreeBSD, and Windows. Older technologies such as the Intel 8259A are the basis for the more modern IOAPIC and the like.

### Supercomputer Server Interrupt Request and Interrupt Service Technology

Some processor families used in the new system architecture for supercomputer servers are based on RISC-V processors and their respective support circuitry as defined in the RocketChip SoC. As such, all code bases include the PLIC (Platform-Level Interrupt Controller) and the CLINT (Core Local Interrupter)/CLIC (Core Local Interrupt Controller)/HLIC (High-Level Interrupt Controller) as Interrupt Controllers. In some variations, the supercomputer servers include a special-purpose Memory Controller. Thus, Memory Controller Interrupt Requests are processed through the CLINT/CLIC/HLIC and PLIC as well as specialized driver software for the ISRs. Similar processing is performed for some I/O, peripherals, and accelerators that are used in the supercomputer servers. Some Server-on-a-Chip or implement one or more PCIe Controllers, so messaging interrupts are included in the supercomputer server interrupt hardware and software.

### Supercomputer Server Hardware Support for Interrupt Requests

The supercomputer servers' processor families include the PLIC and the CLINT/CLIC/HLIC (or multiples of them), and therefore support Interrupt Requests both through messaging and individual bit lines for IRQ signaling. Associated PCIe Controllers provide the required Interrupt Request and Service handling. The supercomputer server DMA Controller (and the IOMMU) supports IRQ generation upon completion of a transfer or a forced abortion of a transfer or timeout. The Memory Controller is enabled to issue IRQs. For example, an IRQ from the Memory Controller indicates a malfunction within the memory subsystem, including the DRAM Controller, the SFI Flash Controller, the Shadow RAM FSM that copies the Flash contents to DRAM and vice versa after a validated Firmware update, and other components that are crucial to the operation of the processor. Any failure of any of the internal components and any failure of the external DRAM or SFI Flash is, in some scenarios, unrecoverable, but at least the OS can be alerted to that failure, to initiate a graceful shutdown and a notification to the user or the Management Center.

Internal support circuitry such as a high-precision multi-channel timer/counter, a watchdog timer and the Memory Controller are connected to the PLIC. The PLIC is configured to support the required IRQ bit lines and signals.

### Supercomputer Software Support for Interrupt Requests

The supercomputer server includes a bootloader, the OS kernel (FreeBSD), and all necessary drivers for I/O, peripherals, Accelerators, coprocessors and DMA Controllers as well as all OS components to boot into userland. ISRs follow best practices in the industry and are multi-core, multi-processor, and multi-threading safe. For example, the ISRs save and restore context, and avoid nesting by temporarily disabling all lower-priority IRQs for the duration of the ISR executing. ISRs are written to support being tied to a specific core (e.g., always tied to the boot core that won a startup lottery, or always tied to core 0, or the like), or allow for allocation based on load or usage factors. The ISR code accounts for the criticality of the IRQ as well as the incidence rate. For reasons of performance and portability ISRs are written, for example, in C.

In some variations, all peripheral IRQs are routed to the I/O frontend processor—the Server-on-a-Chip processor(s)—in a system, and only the system-internal IRQs are in need of processing in the Math Processor or Application Processor, such as memory failures or necessary IRQs from the I/O frontend to the backend processors. In other words, IRQ/ISR mitigation starts in the I/O frontend processor, and it relieves the need for frequent invocation of ISRs in the backend processors.

### Supercomputer Server Architecture: Scalability Benefits

Assume a high-performance processor core in a single-core processor, without an operating system. Also assume that this core can process 1000 instructions in one time unit T. Since this core runs in single-task and single-thread mode, there is no need for a dispatcher or scheduler. As a result, 100% of the 1000 instructions per time unit T are available for application programs.

Assume that same processor and core is deployed with an operating system. The OS will have a scheduler and a dispatcher for tasks and threads, and they use up cycles for OS-internal use. As a result, this core will not provide 100% of the 1000 cycles per time unit T for application software.

A reasonable assumption for OS overhead is about 10%. This processor and core use the same hardware, but only 90% of its rated performance is available for applications.

If that is not enough, then run the same OS on a multi-core processor. Both cores can work in conjunction, with each core providing 900 cycles worth of application software performance, or 1800 cycles in total. That is only the case if there is no need of the application software to exchange status or task information or data across the two cores. In other words, if the data and instruction parallelism is such that no information needs to be exchanged across the two halves of the application running on two cores.

In some scenarios, there is instruction parallelism, so that the cores execute the same code on respective parts of the data, and that is called SIMD for Single Instruction Multiple Data. In some scenarios, there is MIMD, which stands for Multiple Instruction Multiple Data. In that case, multiple processor cores work on multiple different parts of the data set with different parts of the software, meaning executing different instructions from other cores. In that case, data exchange between cores is very frequent.

Both in SIMD and in MIMD operations, processor cores have to exchange information. For example, messages are sent to a shared memory, and status information is retrieved from that same location. This information exchange takes time. In some cases, processor cores are so fast that they exceed the memory's ability to allow reads and writes at processor access times, and as such, those accesses have to be cached. Assume that the operations needed to exchange information take 100 cycles for write, and 100 cycles for read. In that case, a core will spend 200 cycles on information exchange to assess if another core is available to execute tasks that it wants to offload. These cycles are wasted and are not available to other tasks since every task switch will lead to cache misses and therefore stalls. If the core has 900 cycles per time unit T available to application programs, then losing 200 cycles is a large percentage of the available time just for checking if another core is idle and should be avoided. In other words, offloading a task only makes sense if the task is large enough to make the status information exchange and the exchange of application data worth it. In other words, the high latency of inter-processor communication leads to frequent disuse of available resources. Assume a quad-core CPU will have no more than (900−400)*4=2000 cycles available per time unit T for application processing if in fact one IPC is needed within this time unit T. If 2 IPC events per time unit T are required, then the application performance will drop even further as effectively each core can only contribute 100 cycles to the application performance per time unit T.

Now consider a different approach to scale-out. Assume a smaller, cheaper, and less power-hungry set of cores. Assume that each of these weaker cores can process only 500 instructions in one time unit T, and that its inter-processor communication performance is optimized such that a status check (usually a read-modify-write cycle) takes only 20 cycles across cores on the same die, and 40 cycles across processors using a smart memory that is shared across processors.

After subtracting the OS overhead, 450 instructions per time unit T are available per core. However, since neighboring cores can be queried in 20 cycles or cores in a different processor in 40 cycles, it is possible to offload tasks to other cores and to other processors.

Assume there are 16 of these cores in a single processor, and 4 processors of this type connected to each other through shared smart memory. In that case, offloading a task including query and the offload itself only takes 80 cycles or 160 out of the available 450 cycles per time unit T. Because the cores are smaller and need smaller caches, they consume less than 40% of the power of the high-performance cores. Since the smaller cores leave more space on the die to implement special-purpose functions, there is space to implement those in hardware, and as such speed them up drastically. For example, the FFT, matrix, and tensor operations are 40 times faster than those executed in software on the high-performance cores. Instead of several tens of thousands of cycles on the high-performance cores, those math operations are executable in less than 1000 cycles for typical matrix and tensor sizes, and as such, any of the cores can offload those to accelerators.

In the example, there are 64 cores that can communicate with each other in 80 or 160 cycles per time unit T including offloading tasks. Worst case there are (450-160)*64=18560 cycles for application processing per time unit T available.

The 64 low-performance cores will use about the same space as the 4 high-performance cores with their large L1, L2 and L3 caches. Power will be around 50 to 60% lower on the 64-core processor with low-performance cores.

The larger the number of cores, and the more IPC per time unit T is needed, the larger the advantage of the low-performance core.

The scalability advantage over competing architectures is one of the advantages of the new architecture for supercomputer servers.

### Supercomputer Server Architecture: SPD ROM Data Reconciliation

Today's computers—laptops, desktops and servers that make up the basic building blocks for the hyperscalers and Supercomputers and even for some firewalls—rely on memory organized in what the industry calls Dual Inline Memory Modules, or DIMMs. DIMMs are specific to the processor and the version of the Dual Data Rate (DDR) protocol the processor uses. Currently, DDR3 and DDR4 DIMMs make up the majority of the memory that is used. DDR5 is just starting out to enter the market in volume. One item that all DIMMs have in common is the SPD (Serial Presence Detect) ROM on the DIMM PCB (Printed Circuit Board).

These SPD ROMs include crucial information about the DDR DIMMs and the memory modules on the PCBs. This information includes module size, latency, and burst behavior. Memory modules come in a wide variety of sizes, latencies, and burst behaviors. This information is needed so that the processor and the DRAM Controller(s) can appropriately access the DIMMs.

Upon boot (or startup), the processor reads all SPD ROMs of all DDR DIMMs in the system. However, by itself this does not guarantee that the information is correct. Fraudulent manufacturers of DDR DRAM DIMMs have been known to overstate capacity and claim lower latency than what the DDR dice support. The problem with that is that if the processor and DRAM Controller rely on the SPD-ROM-provided data, then a portion of the advertised alleged memory space does not exist, and the memory will be unreliable as it will corrupt data in the memory areas that do exist.

When there is more than one module, the memory controller must account for the maximum DIMM size allowed by JEDEC, the memory standards body, to avoid overlaps. However, that creates a non-contiguous memory map if smaller than the maximum allowable size memory modules are used. This is not desirable as the CPUs MMU now must remap these areas.

Table 1 follows:

| | Memory before remap of | Memory after remap of |
|---|---|---|
| | address space within the | address space within the |
| | memory controller | memory controller |
| Max reserved memory | Actual physical memory | |
| space for module 2 | map of memory module | |
| | within address range | |
| Max reserved memory | Actual physical memory | Actual physical memory |
| space for module 1 | map of memory module | map of memory module |
| | within address range | within address range |
| | | Actual physical memory |
| | | map of memory module |
| | | within address range |

The memory maps in tables 1 and 2 show the memory layout for systems with two or three DIMM slots, and what remapping of the memory can achieve. Reliance on the correctness of the SPD ROM data is not always a good idea, but that is how current processors initialize their main memory.

If the CPU boots using the industry-standard method, the SPD ROM will be read by the CPU and the memory size will be assumed as indicated by the SPD ROM.

If the SPD ROM advertises a memory module size that is bigger than actual, then the nonexistent areas of the memory will always return FF on read. If that memory range is used to store any important data or context, the system will crash. Since modern Operating Systems randomize assignment of memory upon malloc( ), the likelihood of this happening is exactly proportional to the factor by which the true memory size differs from the advertised memory size. The same is true for modern bootloaders. As a result, the CPU will not be guaranteed to boot.

If the SPD ROM reports a memory size smaller than the actual size, then the memory areas will overlap after a remap, but the top-most address range is not going to be affected as that is not subject to overlap, and that is where the BIOS is mapped into. However, upon read there will be conflicts for all reads out of the overlapping areas. The system will be unstable.

None of these scenarios are desirable.

One approach to address the forgoing is used by the new supercomputer server architecture described herein: the DRAM Controllers (as implemented in the supercomputer server legacy support system and in the heterogeneous RAM) verify size information and latency as well as burst behavior autonomously and without any CPU intervention after the link training sequence is finished. For the supercomputer server legacy support system, this ensures that no mismatch between claimed size and actual size of the DIMM can be used to attack the system, even if the SPD ROM misstates the DRAM DIMM characteristics. In the heterogeneous RAM, there are no SPD ROMs, but the size check and the latency and burst checks are crucial for proper operation, and as such, the DRAM Controllers in the heterogeneous RAM autonomously verify size information and latency as well as burst behavior after the link training sequence.

Verifying the DRAM characteristics provides a TLB in the Memory (distinct from TLBs in the CPUs) enough information to remap all address spaces such that the memory array appears as one contiguous memory. If the memory controller remaps the physical address space, then the entire memory array will look like a contiguous space. This relieves the CPU-internal TLB or MMU from having to do that.

The TLB in the Memory can be used to present the heterogeneous RAM as one contiguous memory block to all attached processors. The same applies to the DRAM Controller within the supercomputer server legacy support system. It will present all DDR DIMM memory to the processor cores as one contiguous block.

Another advantage of making the memory smarter is that the Link Training is done by the hardware in the memory controller. Once the memory controller hardware has trained the links, they are up and available for use. Traditionally, this is done by software within the boot core. The problem with that solution is that if the CPU does not manage to train the links, then it will not be able to use the DRAM. Since the training is non-trivial, all algorithms and all intermediate data must be stored in either a scratchpad memory or the local caches of the CPU up and until the DRAM is usable. In some instances, this fails, and the processor subsequently cannot boot. This problem is entirely alleviated using a hardware training method.

To summarize, using SPD ROM data to assess memory size and latency and burst behavior is not secure. The supercomputer server does not rely on the SPD ROM data and instead executes the link training autonomously, then determines the memory characteristics, and then uses that information for DRAM access. The system then remaps the memory to appear as one contiguous block, and once the DRAM Controller is certain that the memory is operational, a Finite State Machine copies the SPI Flash contents to DRAM so that the processors can boot from DRAM. This (protected shadow) ROM now provides the BIOS/UEFI/firmware image within DRAM, which is not only more secure, but also faster than the traditional method.

In an example configuration with 3 DIMM slots the memory map is as follows in

TABLE 2

| Contiguous Address | Non-contiguous | | Contiguous |
|---|---|---|---|
| Space | Memory Map | | Memory Map |
| Address Space | Actual size of memory | Address Space | |
| reserved for Memory | in Slot 2 | remapping with | |
| Slot 2, to accommodate | | TLB inside memory | |
| variable size memory | | controller (e.g., | |
| modules, e.g., 4 to 16 | | CPU sees | |
| GB | | contiguous memory | |
| Address Space | Actual size of memory | inside contiguous | |
| reserved for Memory | in Slot 1 | address space) | |
| Slot 2, to accommodate | | | |
| variable size memory | | | |
| modules, e.g., 4 to 16 | | | |
| GB | | | |
| Address Space | | | Actual size of |
| reserved for Memory | | | memory in Slot 2 |
| Slot 2, to accommodate | | | Actual size of |
| variable size memory | | | memory in Slot 1 |
| modules, e.g., 4 to 16 | Actual size of memory | | Actual size of |
| GB | in Slot 0 | | memory in Slot 0 |

Using the TLB in the Memory in conjunction with (protected shadow) ROM enables a secure and resilient boot process.

### Supercomputer Server Architecture: System Resilience

Any system that is deployed as part of a crucial infrastructure should be hardened against any conceivable attack.

Thus, it should provide system uptime (also called system availability) guarantees.

The system uptime or system availability is the quotient of the number of minutes or seconds in a year and the time during which the system is available during that period. The system availability must account for hardware failures, exchanges, and maintenance, for firmware, operating system and application software updates and upgrades if needed, for downtime during an attack, and for boot time in case a restart is required.

Certain hardware failures can be predicted, and measures can be taken to avoid system downtime during individual component failure. For example, power supplies and hard disks have a known failure rate that is above the failure rate of the processor, DRAM, Flash, or other memories, and above the failure rate of a mainboard or backplane. As such, most systems that must fulfill resilience requirements have adopted a triple modular redundancy (TMR) scheme. Power supplies are the most often used components included in TMR schemes. A server with TMR power supplies would have three power supplies, and the failure of any single one will not affect operations. It will be noticed in the error log, an alert will be sent, and the defective power supply can be exchanged without powering down the server. Oftentimes, a single power supply out of a TMR set can power the server, but under reduced loads or with limited I/O or performance. Similar schemes can be used for hard disks (RAID, ZFS) so that the failure of an individual disk will not affect the operation of the system. Some servers even offer the ability to shut down and exchange individual DRAM DIMMs if one is subject to persistent errors. The supercomputer server intelligent memory subsystems will detect failing memory cells autonomously and take them out of operation, replacing them with spare cells. No CPU intervention is needed for that.

However, hardware outages amount to a small portion of the system downtime. Updates to firmware, the operating system, application software or other configuration-related items contribute a larger proportion to the system downtime.

Here is where hardware support can help improve system availability. In today's systems, updates to firmware, the OS—particularly the OS kernel and kernel-mode drivers—and to some application software require a reboot, which in essence is an update to the affected piece of software on the boot medium, a reset command, a restart of the boot loader, the OS kernel, the rest of the OS after enumeration, and then the restart of the applications. During the entire period, the system is not available for its intended purpose, thus this time counts as system downtime. This time period can easily reach 5 to 15 minutes, and if it has to be done four times per year, the system downtime for software maintenance alone accounts for an hour of downtime per year. Since a year has 8760 hours, the system under consideration cannot provide a system availability guarantee of more than 99.99%. That is not quite the “five nines” or 99.999% that most operators look for.

In the supercomputer server processors, updates and upgrades to the firmware, the OS kernel, and to kernel-mode drivers do not require a reboot. Updates to application software only require the application to restart. As a result, the system uptime guarantees are much higher. An additional contributing factor to the supercomputer server improved availability is that all processors are enabled to operate from two different sets of firmware, OS kernel, kernel-mode drivers, and enumerated peripherals, such that one set remains a “Golden Set” for fallback in case the update fails. Fully encrypted storage of these items to prevent tampering is implemented in hardware. The “Golden Set” and the updated sets are also automatically signed and authenticated upon verification, and upon preboot their signatures are verified, as is the authority of the administrator initiating any update.

Therefore, it is impossible to bring a supercomputer system down with an attack against the contents of the SPI boot flash, even if compromised firmware is installed and an unauthorized update sequence is initiated. An overwrite of the firmware in the SPI boot Flash with an external SPI programmer will not be able to compromise a supercomputer server system implemented using the new architecture.

Together with the continuous availability of a “Golden Set” of firmware, OS kernel, kernel-mode drivers, and enumerated peripherals, any attempt to start from a corrupted image is prevented, and therefore, the possibility of a “Rolling Recovery” is averted. “Rolling Recoveries” are possible in TPM-equipped systems when the system boots and the hash from the system boot image does not match the hash stored in the TPM, resetting the system, and sending it into an infinite loop of booting, comparing non-matching hashes, and subsequent resets.

Systems in accordance with the new supercomputer server architecture do not exhibit that behavior, making certain that the system boots properly and that the system boots into a known good state, and as a result, improving the probability of a successful reboot after a reset if the need for a system reboot arises.

### Supercomputer Server Architecture: Continuous Availability

Continuous Availability is defined as the ability of a system to execute its intended tasks at any time, without interruption. In general, this is assumed to provide a better availability of the system than a high-availability system, which typically achieves a 99.999% (also referred to as “five nines”) availability to execute its intended tasks. The downtime (time during which a system is not available to execute its intended tasks) includes the times during which hardware failed, power was interrupted, software crashed, or an update to firmware, OS kernel, or kernel-mode drivers were necessary.

For perspective, 99.999% system availability means that the system is down for no more than 8 minutes and 45 seconds per year. Continuous Availability therefore assume a downtime lower than that, typically less than 60 seconds per year.

Further clarifications and implications as well as the exact definition are available at NIST, the National Institute of Standards and Technology, as well as at its European Counterpart, the European Committee for Standardisation (CEN), the European Committee for Electrotechnical Standardisation (CENELEC), and the European Telecommunications Standards Institute (ETSI). The 800 Series of NIST documents is a frequently referred-to publication in this subject matter, and it can be found here: https://csrc.nist.gov/glossary/term/resilience

To achieve Continuous Availability, the supercomputer server avoids any reboot for an update to the firmware, operating system or even the hypervisor that will take the system offline or make it unavailable to its intended purpose in any other way. The supercomputer server and the user of a continuously available system can tolerate a temporary reduction in available processing capacity and available memory. An update to any software on top of the application processor's host OS is beyond the scope of the hardware and must be dealt with by the application itself (restart and resume with all context intact), or by an extension to the Operating System.

The prerequisite is that the system is equipped with assured firmware integrity and resilient secure boot, (protected shadow) ROM and (zero thread) MemCopy technologies. The supercomputer server BMC has the capability to verify these requirements to the host OS. When the BMC has verified that the necessary hardware is present, it will allow In-Service Firmware and OS kernel updates and notify the host OS of that capability.

In summary, after boot in any system equipped with the technologies as outlined above:

1. The SPI Flash includes two images.

2. B is the active boot image, and G is the known-good boot image deemed as the fallback golden inactive boot image.

3. The contents of the BIOS/UEFI and other supercomputer server firmware has been copied from SPI Flash to DRAM into the boot area B and is decrypted.

4. The entirety of the firmware resides in an area B of the DRAM that is marked as read-only for the application cores, the network interface cores, and the mass storage cores. It cannot be read from or written to by the BMC core via software either, but the BMC core can trigger reads and writes using the Shadow ROM FSM from the encrypted SPI Flash to DRAM and from DRAM to the encrypted SPI Flash.

5. The application cores, the network interface cores, and the mass storage cores will have booted from the BIOS/UEFI and other supercomputer server firmware image in DRAM and then continued booting from the boot medium as identified in the BIOS/UEFI settings. The boot sequence is always as follows: BMC core first, then mass storage cores, then the network interface cores, and then the applications cores.

6. The application processor cores, the network processor cores and the mass storage processor cores are running their respective Operating Systems and application software including the OS Kernel mode drivers for the hardware, which are the hypervisor or FreeBSD for the application processor cores, pfSense and add-ons for the network processor cores and FreeBSD and SAS, SATA, M.2 over PCIe, RAID drivers as well as ZFS and Lustre applications for the mass storage processor cores.

At this stage, the application processor cores, the network processor cores, and the mass storage processor cores are all active. The system responds normally to all valid requests and filters incoming and outgoing traffic according to policies and the Oinkmaster database at https://www.snort.org/ and SQUIDGUARD databases http://www.squidguard.org/ here.

Following is an example implementation for an update or an upgrade to avoid causing any system downtime:

1. Verify that the person requesting the update or upgrade is an authenticated admin/superadmin with a valid passphrase. Credentials must match the contents of the Root of Trust vault within the encrypted BMC.

2. One of the application cores will then transfer the update or upgrade to the firmware, operating system, or the hypervisor to the BMC's protected memory area B1 via its IOMMU.

3. The BMC will then verify the signature(s) of the update or upgrade image. If the signature does not match, then the BMC will alert the application processor's operating system of the mismatch, and it will deny any subsequent request from application processor cores to install this update or upgrade image. If the signature matches and is valid, the process can advance to the next step.

4. The BMC will verify that the current firmware in the SPI Flash and the DRAM match by initiating a Shadow ROM FSM transfer from SPI Flash into a secure DRAM memory range B2 while decrypting the contents and executing a subsequent compare operation between the Shadow ROM contents in DRAM from the initial startup (B) and the newly copied version (B2). If the images do not match, either the image in DRAM has been altered, or the image in Flash has been altered using an external SPI programmer. Since the DRAM image is read-only, the only way it could have been altered is by data corruption caused by a DRAM hardware error. The only way to change the SPI Flash image is via an external SPI programmer or through a failed prior firmware update. Non-matching B and B2 images indicate either a severe hardware problem or an attack. In case of a non-match, the BMC will use its hash engine to verify the hashes of B and B2 that are part of the image itself. If image B matches its hash, then image B is valid. The BMC will also verify the image B2's hash. If B is valid, then B2 must not match its hash and be invalid. If that is the case, then the BMC will first restore the valid image B to the SPI Flash by instructing the Shadow ROM FSM to copy image B back to the SPI Flash while encrypting it. Once that has finished, the BMC will repeat this procedure but instruct the Shadow ROM FSM to use a new non-overlapping memory range B3 to rule out a DRAM malfunction, and it should then see matching B and B3 images. The hash verification runs in hardware in parallel to the comparison.

5. The BMC will now use the Shadow ROM FSM to copy the boot image from B to the SPI Flash into the memory area for the Golden image G, and then do the same for the image in B1 to be copied to the new active boot image memory within the SPI Flash.

6. The BMC will now start a watchdog timer and reset itself.

7. The Shadow ROM FSM will copy the boot image B1 from SPI Flash to memory area B, and as soon as that process is finished, the BMC will boot from B.

8. If the BMC finishes its boot process before the expiration of the watchdog timer, then the boot process is deemed a success, and it will proceed to the next step. If the BMC does not reset the watchdog timer, then the expiration of the watchdog timer will reset the BMC again and instruct the Shadow ROM FSM to copy boot image G to memory area B. In this case, the update or upgrade to the firmware, operating system or the hypervisor is terminated.

9. If the BMC booted with image B successfully, then it will notify the supercomputer server OS kernel driver that an update or upgrade to the firmware, operating system or the hypervisor is pending.

10. The OS kernel driver will now shift all computational loads onto the first half of the application processor cores, the first half of the network processor cores and the first half of the mass storage processor cores.

11. The second half of all cores will be shut down and their associated memory will be made shareable.

12. The second half of all cores will now be instructed to restart with the new OS, OS kernel or hypervisor in the appropriate memory location, with the lottery selecting which core to use restricted to the respective half of cores. The boot sequence is as follows: mass storage cores, then the network interface cores, and then the applications cores.

13. Once all second half cores are up and the entire second half of the system is working normally, the process repeats for the first half of all cores.

14. After the reboot of the first half of all cores, the entire system is working normally and has been fully updated.

As a result, the system never becomes unavailable even during an update or upgrade to the firmware, operating system, or the hypervisor other than a brief outage of the BMC. However, even in case of a severe attack against the system such as an overwrite of the SPI Flash with an external SPI programmer, the system cannot be compromised.

Thus, the supercomputer server systems provide for continuous availability through additional hardware, firmware, and drivers as well as a tight integration of the BMC into the security mechanisms, and therefore the system will always boot into a known good state, and as a result, improving the probability of a successful reboot after a reset if the need for a system reboot arises. As stated before, the supercomputer server systems do not exhibit a system-down situation for an update to firmware, OS kernel, kernel-mode drivers, and enumerated peripherals. In very few cases will a system-down reboot be necessary.

Supercomputer Server Architecture: Secure Firmware Update with Redundancy Preface

Current Firmware updates are not secured against malicious attacks, and most Firmware update mechanisms cannot deal with power outages during an update and will corrupt the Firmware image in the Flash, and thus will “brick” (permanently disable) the device. As a result, a more secure Firmware update mechanism must be devised, and it must consider that during a write-back to Flash, power can be lost. The simplest way to do so is a combination of verifying the firmware by checking its signature and credentials of the administrator and deploying a dual-Image mechanism.

### Context

Every processor family has a certain hard-coded address at which it starts its boot process. For the supercomputer server RISC-V processor this is 0x1080000000 (or at 66 GB). Traditionally, a processor boots out of an SPI (Serial Peripheral Interface) Flash and executes that code in situ, e.g., from within the Flash memory. To accomplish that, the contents of the SPI Flash memory is mapped into a non-occupied region of the address space, usually a range at the very top of the physical address space available. That way it is made certain that the memory-mapped SPI Flash contents does not collide with physical memory as at this stage of the boot process the TLB has not been loaded, and a CPU TLB (Translation Lookaside Buffer, aka MMU core) address remapping is not possible.

The drawbacks of this traditional method are plentiful. First, the integrity of the archive making up the Flash (and therefore boot code) image cannot be verified before the processor boots. Second, executing code out of a Flash (in situ) is slow. Third, a Flash update can fail, and if the image is corrupted, the mainboard is sent to the manufacturer to reflash the Flash with a HW Flash programmer. Fourth, there is no way to protect against an attack during which the Flash memory contents is overwritten with malicious code by using a Flash programmer the way the factory uses them. As a result, the current way that processors boot and update the firmware is not secure, does not lend itself to in-service updates and upgrades, and carries the risk of bricking the system.

### Hardware and Software Implementation

In supercomputer server processors in accordance with new architecture, the methodology of booting, updating, and upgrading the firmware and authentication of an update/upgrade is different. Upon startup, the RESET signal for the CPU cores inside the processor are not deasserted until the SPI Flash contents is copied into DRAM by a hardware FSM (“Shadow Read Only Memory Finite State Machine”). When this process is completed, the RESET for the processor cores is deasserted, and the core(s) can boot. In other words, upon startup the hardware FSM copies the contents of an SPI (NOR) flash to the memory address range 0x1080000000 to 0x1090000000-1 in DRAM, and when the process of copying the contents over is completed and confirmed to be complete and verified, then the CPU cores can boot a guaranteed authentic and verified firmware image.

The SPI Flash contents is protected by a scrambler and/or by a crypto engine. The same key is used for scrambling or encrypting the DRAM contents, and as such, no decryption and re-encryption is necessary. Some implementations use different keys for the Flash and the DRAM.

To enhance security and leave no room for a backdoor, the Key Management Unit creates an immutable and a software-inaccessible UUID (Universally Unique IDentifier) that can be used to authenticate the chip for attestation, to verify authenticity, and to make sure that the processor is genuine by comparing the hash of the UUID hash with an entry in a database. The UUID can only be referenced by software, but it cannot be read, overwritten, or modified by software. It also creates 16 asymmetric key pairs for general-purpose internal cryptographic operations, and one special asymmetric (“primordial”) key pair for supercomputer server Firmware updates. Upon manufacturing and initial startup there is a one-time possibility to load unencrypted firmware with the firmware updater utility from the SPI Flash to DRAM. Once that image has been loaded, a fuse is blown, and the public key of the pair is exported to a specific memory location in DRAM that can be read by and displayed through the firmware update function. Loading of unencrypted firmware images is made impossible as the Unified Memory Controller will from now on decrypt all data from DRAM to the processor using the private key of the primordial key pair. Conversely, the Unified Memory Controller will encrypt all data going to the DRAM with the public key of the primordial key pair. This methodology can be modified to use a symmetric key instead of an asymmetric key pair.

The Shadow ROM FSM within the Unified Memory Controller does not allow any access from the processor directly to or from the SPI Flash contents. As a result, all firmware updates must be posted to DRAM after they were verified to be authentic, genuine, and posted by an authorized admin through the firmware updater part that runs on the supercomputer server processor.

One function of this firmware updater tool is to then request the Shadow ROM FSM to copy the new and verified firmware image to SPI Flash. As the DRAM contents is scrambled or encrypted, there is no need to descramble or decrypt this image to be posted to the SPI Flash. In some implementations, the Unified Memory Controller enables using separate keys, whether they are symmetric or an asymmetric key pair.

This process is the same for updates to the firmware of the system integrator. However, as the System Integrator will want to use their own key pair, the firmware update utility needs to support a few more functions to enable this. The most important function is to support commands to the Key Management Unit to create a secondary set of key pairs that gets sent to the Unified Memory Controller to enable the DRAM-Controller-internal crypto engine to encrypt and decrypt all data in DRAM to a knowable and therefore retrievable key pair. This is similar to the supercomputer server firmware update function that retains a copy of both the public and the private key of the asymmetric key pair to encrypt an updated FW image and to decrypt the SPI-Flash firmware image upon boot. Similar to the function that posts the supercomputer server public key to a DRAM space for retrieval through and by the firmware updater, this function posts the public key of the key pair to the firmware updater for retrieval by the System Integrator. That allows the System Integrator to use a key pair that is not known to the supercomputer server so that System Integrator secrets stay protected and are not accessible by anyone, not even the supercomputer server, outside of the System Integrator.

All other firmware update functions of the firmware updater tool/utility are similar in function between the Firmware update utility for the supercomputer server and for System Integrators.

Some implementations support a dynamic distribution of the sizes of the firmware between the supercomputer server and the System Integrator. The total SPI Flash size is 256 MB, and the non-redundant sizes are 128 MB for each entity. If redundancy is required, the sizes are 64 MB-4 KB for each image. The 4 KB are located at the top of the address space, and these 4 KB are used to indicate that a Firmware update/upgrade process has terminated normally and successfully. Ideally, those 4 KB at the top of each respective image are left empty (e.g., zeroed out). However, if versioning is needed, the hardware and software can be adapted to accommodate this. This has implications on the total usable space for the supercomputer server and the System Integrator Firmware image size. In redundancy mode, each image can be no larger than 64 MB-4 KB. In non-redundancy mode, each image can be no larger than 128 MB-4 KB. There are some applications of this scheme in which the two top 4 KB blocks are unusable for Firmware code, namely if a 4 KB block is used to store configuration data that is verified by the enumeration to detect hardware changes.

The firmware updater utility accounts for this. If the device is configured for redundancy, then the System Integrator cannot change it to non-redundancy as it would pose the risk of exposing unencrypted code to the System Integrator.

The update process and boot process for redundant and non-redundant configurations are similar but not identical.

In redundancy mode, the first 64 MB block is occupied by one of the two supercomputer server boot images, and the second one by the second of the supercomputer server boot images. The third 64 MB block is occupied by the first System Integrator application Firmware image, and the fourth block is occupied by the second System Integrator application Firmware image.

The memory map looks like this (Table 3):

TABLE 3

| | | Boot Memory |
|---|---|---|
| | Boot Memory | Address Space |
| | Address Space with | without |
| Address | Redundancy | Redundancy |
| 0x1090000000 | System Integrator | System Integrator |
| | Firmware Image B | Firmware Image |
| | (64 MB) | (128 MB) |
| | System Integrator | |
| | Firmware Image A | |
| | (64 MB) | |
| | Firmware Image B | Firmware Image |
| | (64 MB) | (128 MB) |
| 0x1080000000 | Firmware Image A | |
| | (64 MB) | |

If redundancy is configured, then the Shadow ROM FSM will look for an empty 4 KB block at the end (e.g., top) of each firmware image. It will copy the supercomputer server image with an empty last block to the boot address. It will do the same for the System Integrator application Firmware image with an offset of 64 MB for redundant images, and with an offset of 128 MB for non-redundancy applications. The System Integrator firmware includes a new target jump address in the first image if the second image shall be used.

Upon firmware update, the updater tool will copy the supercomputer server FW (Firmware) image to specified DRAM location as described above, and then copy it back to the SPI Flash. The image must be 64 MB in size, with the top 4 KB being filled with 0xFF, and the Shadow ROM FSM will copy 64 MB back to the SPI Flash. Once that is completed, the Shadow ROM FSM will overwrite the top 4 KB with zeroes. This is an FSM function, but it must be triggered by the Firmware updater software. That way it is insured that if the top 4 KB are zeroes, the image was transferred in its entirety and correctly and completely. If two valid images are found, the Shadow ROM FSM will copy the image with the lower address range to DRAM.

A similar function is included in the FW updater tool for System Integrators. The tool verifies signatures and thus is enabled to distinguish the FW update to the supercomputer server FW from a firmware update to the System Integrator Firmware image.

### System Integrator Firmware Update Procedure

The supercomputer server's firmware update mechanism for System Integrators is loosely based on a TLS (Transport Layer Security) handshake. A vendor of the supercomputer server operates as a Certificate Authority (hereafter, “CA”). The CA generates a root keypair. The root keypair's public key is embedded into the firmware. The root keypair is used to sign an Ephemeral Key (hereafter, “EK”). The EK is distributed to the System Integrator, and hereafter, the update process begins.

(1) Out-of-band, the System Integrator signs a firmware image using the EK private key.

(2) The signed firmware image is delivered to the supercomputer server processor across an unspecified channel. The signed firmware image is stored in DRAM.

(3) The supercomputer server processor uses the root keypair's public key to verify the EK's public key, which then verifies the signed firmware image. Only if the update is verified will the processor proceed to the next steps.

(4) The signed firmware image is copied to yet another location in DRAM, this time to stage an update.

(5) A hardware FSM copies the verified contents from DRAM to an SPI chip for retrieval after a power cycle or a triggered in-service firmware update command.

### Supercomputer Server Architecture: Benefits of (Zero Thread) MemCopy

A (zero thread) MemCopy is a new aspect of performance and security. Some operating systems separate data in kernel space and user space to ensure the integrity of the OS, the data, and the application.

The (zero thread) MemCopy of the new architecture for supercomputer servers is implemented in processors, accelerators, and an intelligent memory subsystem (e.g., smart memory). For example, the (zero thread) MemCopy engine is an IOMMU (that in turn is an advanced DMA Controller) that is capable of transferring data from one memory space to another, while evaluating and respecting all security bits such as the PMP tags. If a CPU core needs to transfer data from kernel space to user space or vice versa, the CPU core instructs the (zero thread) MemCopy engine to do so by providing start address and end address for both source and target space, and then waits for completion, during which time it can do something else. When completed, the (zero thread) MemCopy engine will notify the processor that the command has executed to completion (or has irregularly terminated due to rules violations). As such, the command takes zero CPU threads other than the setup of the transfer. The (zero thread MemCopy is efficient, autonomous, secure, and flexible. This is useful, for example, in applications in which data arrives, an application that is not kernel-mode must process its arrival, and then a kernel-mode piece of software has to evaluate it, determine what to do with it, and then hand it back to a user-mode application for further processing. Using the (zero thread) MemCopy hardware and firmware, it requires no software copying.

In the new architecture for supercomputer servers, any processor core can trigger a memcpy command, with scatter/gather processing and optionally with reversing the direction of the memcpy command so that the data can copied in ascending order from the source but in descending order to the target if so required.

Separate logic in the intelligent memory subsystem is enabled to execute this memcpy command, and no thread on any CPU core is occupied by this command. Both source and target memory areas are accessible to other processors and cores and the IOMMU even during the transfer, and if any areas are located within a coherency domain, the cache coherency is maintained automatically by the logic in the intelligent memory subsystem.

### Supercomputer Server Architecture: Resilient Secure Boot

In some microprocessor systems, the address space of the microprocessor is during boot-up in real mode, e.g., there is no translation from physical addresses to logical addresses.

For example, the lower range of the address space is occupied by DRAM (main or working memory), and somewhere near the top, there is a memory device that includes what today is called the bootloader. This memory device in the early days was a ROM (Read Only Memory), and as such it could not be changed or updated if bugs were found, or functions needed to be added. Later, EPROMs (Erasable Programmable Read Only Memory) were used, then EEPROMs (Electrically Erasable Programmable Read Only Memory), and today Flash memory is deployed to make updating and upgrading the bootloader and firmware easy. However, what has not changed is that the processor executes the instructions in the bootloader or firmware in situ, e.g., inside the chip that holds the bootloader or firmware. In a PC (desktop or laptop) or an x86-64-based server, which is the BIOS (Basic Input Output System) or UEFI (Unified Extended Firmware Interface). Once the bootloader is loaded and executed, the second stage of boot can begin. Usually, that entails loading the rest of the UEFI firmware from disk, and then the OS Kernel is loaded with all necessary drivers and APIs, and lastly, the rest of the OS is loaded, and the user can log in.

While this has served the industry well for as long as computers were not connected to the Internet, it is not adequate any more in today's environment.

Both a malicious user and malicious software can modify the bootloader and firmware, without being detected. Once the malicious bootloader or firmware have been installed, anti-virus software can be disabled, snooping a keyboard or other devices can occur, and all username/password combinations can be harvested and sent to a remote server for further exploitation. Furthermore, keys including those for authentication and attestation can be manipulated, and as a result, the device cannot be trusted any more. Its authenticity is broken, and oftentimes, this loss of authenticity goes undetected. This is bad enough for a laptop, a phone, or a tablet, but if such a breach occurs in a server, the security of the data of many people—users or not—is compromised. The industry has long grappled with a solution to the boot problem, but no solution that is bulletproof has emerged. For over 20 years, the TPM (Trusted Platform Module) was the go-to solution for security. However, even an activated and properly configured TPM cannot guarantee the integrity and authenticity of the bootloader or the firmware, and neither can it guarantee the validity and authenticity of a firmware update. Most data center operators deactivate the TPM because it interferes with the necessary remote administration of servers, and even if it is active, it does not prevent attacks against a servers' onboard Baseboard Management Controller (BMC).

Thus, a new approach to booting a computer is needed. First, the new scheme must guarantee the integrity, validity and authenticity of the bootloader and the firmware at all times. It must make sure that an update to the bootloader and the firmware is not predicated on the signature verification on either the host or a computer that is used as an external Operation, Administration, Maintenance and Provisioning (OAM&P) station. Attacks against firmware update tools that run on and verify the signature of the firmware update on an OAM&P computer or the host itself can be successful—all it takes is a disassembler with the ability to annotate the disassembled code, and replacing the if-then-else construct that determines the authenticity of the update with a number of NOPs. The signature verification must occur inside the device that provides the server with the boot code at boot time.

All bootloader and firmware code are obfuscated to hinder successful disassembly.

### Side Channel Attacks and Attack Mitigation

In a server, certain other functions and features must be present to make a successful breach as difficult as possible, including those that can be characterized as side channel attacks (SCA). These include varying the supply voltage or the input clock frequency (or create intended jitter in the clock period) by an attacker who is in physical possession of the server. Differential power analysis has been used to zero in on keys, using a sequence of cleartext or ciphertext that follows certain patterns. An enhanced BMC is enabled to detect these attacks and help defend against them, by both monitoring input voltage independent of the Voltage Regulator Module (VRM), and by using internal circuitry to detect clock frequency and clock period variations. It is further enabled to store the evidence such that the attacks can be replayed, understood, and help create and distribute defenses against those novel attack types, in conjunction with a cloud-based backend that will need to support in the machine learning (training) part of Artificial Intelligence (AI). Those updated rules are then distributed back to the Secure BMC, and its AI Inference Engine will then be able to fend off all future attacks without having to resort to software. Due to the computational requirements, SCAs will first be defended against in high-value targets such as servers, and the supercomputer server has a hardware ASIC solution to that. In some contexts, this solution this solution is usable in desktops, laptops, tablets, and phones.

### HSM

Per Wikipedia, a “hardware security module (HSM) is a physical computing device that safeguards and manages digital keys, performs encryption and decryption functions for digital signatures, strong authentication and other cryptographic functions.” Typically, HSMs are attached to the host processor(s) via PCIe. This leaves them vulnerable to snooping via a PCIe diagnostics board since the communication between the processor(s) and the HSM is not encrypted. The supercomputer server solves that problem by integrating HSM functions into the Server-on-a-Chip processor, and the internal interconnect between the HSM-equivalent and the application processor cores is not observable from outside of the chip.

### IOMMU

Wikipedia explains an IOMMU with “In computing, an input-output memory management unit (IOMMU) is a memory management unit (MMU) that connects a direct-memory-access-capable (DMA-capable) I/O bus to the main memory. Like a traditional MMU, which translates CPU-visible virtual addresses to physical addresses, the IOMMU maps device-visible virtual addresses (also called device addresses or I/O addresses in this context) to physical addresses. Some units also provide memory protection from faulty or malicious devices.”

This explanation is neither complete, nor is it entirely correct. An IOMMU provides the same functions that a CPU-core-internal MMU provides, except for devices that either use memory-mapped I/O or use a DMA Controller to copy data between memory or I/O devices. The IOMMU deals with address translation services for peripherals and DMA, and as such could be used to circumvent protected memory spaces. It essentially is a translation device (or Look Up Table, LUT) that translates physical addresses to logical address and vice versa, and it should include in its results all CPU-enabled security features such as forbidden areas, no-execute areas, exclusive areas and restricted access areas including key pointers if the area is encrypted to a certain key or key pair. That makes it a complex device as its contents must be managed and kept coherent with the CPU cores' MMU or TLB (Translation Lookaside Buffer). For example, if the CPU core's policy in its internal MMU forbids access to memory area A, then this information must be mirrored in the IOMMU. If this restriction is not mirrored in the IOMMU, then an attacker needs to use the DMA Controller within the IOMMU to copy contents from memory area A to memory area B that does not have these restrictions, and then the contents of memory area A is available in non-restricted memory area B where a malicious piece of software can access it and exfiltrate it. This is independent of whether the addresses are physical or logical addresses as this translation is done in the IOMMU, but without the protection bits set in the IOMMU security measures of the CPU can easily be circumvented. In other words, the IOMMU is a shared resource across all processor cores, the contents of the IOMMU must be kept coherent with the MMUs inside the CPU cores, and the hardware IOMMU must be protected against attacks. The supercomputer server implements an IOMMU that is hardened against such attacks.

### The New System Architecture for Super Computers Technique

The supercomputer server comprises a novel and truly secure processor with an internal BMC that deploys cryptographic functions in a way that makes a successful differential power analysis attack extremely unlikely, uses AI at the edge and in the cloud to learn new attack vectors and behaviors, and that guarantees the integrity of the bootloader and firmware for the BMC and—if so configured—for the host, while at the same time monitoring and collecting evidence of unusual behavior and environmental conditions that might indicate an attack by someone in physical possession of the device. All physical external memory is obfuscated and no cleartext is stored any external memory (SPI Flash, DRAM and optionally an M.2 disk). The M.2 disk can be used for logging, for secure storage of the hosts' firmware and OS and all system integrators' applications.

In some scenarios, a Server-on-a-Chip provides more than the NIST-prescribed cryptographic standards for bulk cryptographic services, and key management and key generation features provide additional security over traditional HSMs. The Server-on-a-Chip also provides an immutable UUID that can be used for multiple authentication and attestation purposes within a standard challenge protocol. The Server-on-a-Chip processor provides all HSM functions within the processor, so no external interface is needed that would be subject to snooping.

The HSM functions are implemented in a secure hardware enclave within the processor and provide only those services that are integral to the operation of the processor itself, such as the UUID, key generation and management, attestation, authentication on multiple levels, firmware update and upgrade functions, resilience, and in-service upgrade for the use of multiple secure boot images. HSM functions are executed using a mailbox, and the HSM has its own hardware-separated memory in the processor's DRAM.

Bulk cryptographic functions for SSL/TLS or IPSec VPNs and other uses are implemented in a separate accelerator from the HSM equivalent module. Those functions include all NIST-required functions, and as a superset, the supercomputer server implements all SHA-3 contenders such as KECCAK and Blake2/3 as well.

Side Channel Attacks are mitigated by design by ensuring that the power consumption of the bulk cryptographic function module is constant, with an added white noise over the baseline. Detection of voltage fluctuations imparted on the chip despite SPI/I2C-connected external VRMs allows the chip to react to this type of attack, whereas variations of the input clock frequency or period are mitigated by using an internal PLL and clock recovery unit as well as an internal clock multiplier that is impervious to those variations over a wide range. Should the output clock frequency or period fall outside of an acceptable window, the processor will shut down and delete all session keys by deleting the single key that allows cleartext access to the former. Moreover, the processor will log all suspicious events and can make those available for further analysis if the on-chip edge-based AI for inference has caught an event but cannot ultimately and decisively create a new ruleset or threat database entry locally.

The supercomputer server IOMMU has memcopy functions built in and uses a TLB in the Memory to enable physical to logical address translation as well as for observing memory access restrictions as set forth by the CPU core's MMU, enabled with a coherency protocol across them. As a result, the supercomputer server IOMMU is enabled to copy data from memory-mapped I/O to DRAM and vice versa, as well as from I/O device to I/O device, and from memory area to memory area. In some scenarios, it does not allow for scatter-gather processing.

### Feature Comparison

Various features are compared as follows (Table 4):

| | This Architecture | TPM-based | Benefits |
|---|---|---|---|
| Guaranteed FW | yes | no | OS can build off |
| Integrity | | | known good state |
| SCA Mitigation | yes | no | Enhanced |
| | | | robustness |
| IOMMU | yes | Depends on | Full protection of |
| | | host CPU | I/O |
| Integrated HSM | yes | no | No externally |
| | | | observable data |
| FW Auth. | yes | no | Flashed FW |
| within HSM | | | guaranteed |
| | | | unmodified |
| Extensive | yes | Optionally | External analysis |
| logging | | in host | possible in near |
| | | | real-time |
| Edge Inference | yes | no | Lower latency to |
| AI | | | detection |

### Supercomputer Server Architecture Heterogeneous RAM Versus High-Bandwidth Memory (HBM)

Many processors have individual cores that have an L1 cache associated with them. The L1 cache includes two parts with one holding data and the other one holding instructions. The goal is to make sure that the core does not run out of data or instructions, avoiding a stall. The larger the discrepancy between the core performance and its main memory is, the larger the L1 cache has to be to mask the latency of DRAM. Since server processors these days are all multi-core designs, the cores are arranged in groups of 4 cores with a shared L2 cache. This is usually a unified cache, and it does not distinguish between data and instructions. It is also usually inclusive, meaning that all L1 cache contents are mirrored in the L2 cache. That way, cache coherency schemes can be used to share data across cores, and while access latencies to the L2 cache are larger than the latencies to access the L1 caches, they are still lower than DRAM access. Most server processors include more than 4 cores, and so the core clusters of 4 are then combined into a cluster of clusters, with a shared L3 cache. This cache is larger and slower (both in terms or latency and bandwidth) than the L1 or L2 caches, but lower latency than DRAM, and the L3 cache can be used to share data across clusters. It will usually also be an inclusive and unified cache. Unfortunately, these days, even that is not enough. As a result, a special high-performance, lower-latency version of SDRAM has been created and is being introduced as HBM, or High-Bandwidth Memory. This HBM is very wide, and it is intended to be connected as a 3D stack onto the processor die or substrate.

While HBM uses 3D-stacked DRAM dice, HBM SDRAM is designed to provide lower latency than standard DDR3/4/5 SDRAM, and it is wide—usually 1024 bits with 8 channels of 128 bits each. With data rates of 2 GHz on the interface, HBM provides up to 256 GB/s of bandwidth. HBM is used as an L4 cache because the CPU designers are running out of space in L1, L2 and L3 caches. Due to the size of HBM, and the fact that Operating Systems cannot make use of that much cache, HBM memory is oftentimes separated into an inclusive and unified L4 cache and scratchpad memory.

This implies that modern processors include the cluster of cores, the L1, L2 and L3 caches—all of them SRAM—and the memory controllers for external DDR3/4/5 SDRAM DIMMs, the HBM memory controller, and the HBM SDRAM itself in a 3D stack. Oftentimes, even PCIe controllers and a limited number of PCIe PHYs are on the processor die or an in-package substrate.

The problem with this approach is that more power consumption is moved onto the CPU die or substrate, and more heat must be removed from the CPU die or substrate. It fundamentally does not solve the problem of access performance to its main memory, and inter-processor communication is not improved by this architecture either. As a result, power and heat are concentrated on the CPU die or substrate without fixing the underlying problem of memory access performance.

### Power and Heat Implications

The supercomputer server uses a novel system architecture with a novel partitioning of general-purpose compute, acceleration, and memory. In this novel system architecture, a unified ultra-high-performance interface is used to connect processors, accelerators, and memory, therefore alleviating the need for all DRAM controllers on the CPU die or substrate, and freeing up pins from DRAM control duty, and by reassigning them to a unified interface, e.g., UHPI using a (latency-reduced) SerDes. Instead of the processors, the heterogeneous RAM (e.g., smart memory) becomes the focal point of data exchange between processors, accelerators, and memory with a multi-homed architecture. In this architecture, all memory controllers as well as the DDR5 SDRAM dice and the Flash or PCM dice are 3D stacked within the heterogeneous RAM device, reducing the power consumption and the heat generation on the CPU die or substrate and move that to the heterogeneous RAM. Doing so relocates power consumption and heat generation to a device that is not the CPU. All data exchanged through the heterogeneous RAM will be cached in an SRAM cache inside the heterogeneous RAM, and if needed, drained to DRAM or Flash (or PCM) without CPU intervention. In some examples of the heterogeneous RAM, there is an included HBM controller and included memory, e.g., to improve applications where the SRAM is not large enough and/or the DDR5 SDRAM is not fast enough. The power envelope of the heterogeneous RAM allows for that. The TLB in the Memory ensures that the heterogeneous RAM memory for each attached processor appears like a contiguous memory space. The TLB in the Memory includes all privilege and security tags (such as the x86-64 no execute and the RISC-V PMP tags) for that memory region so that no attacks against the memory can compromise the security of the system.

In total, the supercomputer server conserves power over traditional architectures as there are no external SSTL-2 interfaces for DRAM that consume a large amount of power per bit transferred (in technical terms, the energy-efficiency is higher on a pJ/bit basis), the supercomputer server achieves higher performance with smaller L3 caches in the processors and accelerators, and there is no need for the HBM and its controller as an L4 cache in the processors and accelerators. The TLB in the Memory is enabled to present the physical memory as one contiguous block to the CPU, and as a result, the CPU's MMU has to conduct fewer lookups and address translations, further reducing its power consumption.

The supercomputer server reduces the need for cache coherency traffic, and thus reduces overall power consumption of the system since the coherency logic by its definition must be fast and therefore is consuming large amounts of power. If a memory region is part of a coherency domain, then a core accessing it will need to know prior to using the data included in that area if it has been modified, is exclusive, shared, or invalid.

In some implementations, the supercomputer server provides for adding HBM and the controller to the SRAM cache in the heterogeneous RAM. In that case, there is still a reduction in the power consumption over traditional architectures as the heterogeneous RAM is a shared resource for up to 4 processors, and as such, the power consumption of an added HBM reflects only a quarter of that of a dedicated HBM in a processor.

The supercomputer server also intercepts and accelerate RMW operations from a processor (see below), and that reduces CPU stalls and therefore saves power.

Another aspect is a (zero thread) MemCopy that alleviates the need of a RISC CPU core to execute a memcopy in software. Instead, a finite state machine in the heterogeneous RAM executes that memcopy in hardware and saves power by doing so.

### Performance Implications

Separate and autonomous logic in the intelligent memory subsystem within the heterogeneous RAM, e.g., an (autonomous) memory command processor, will execute all internal functions without any CPU intervention, and all memory commands will be executed as if the heterogeneous RAM were a very large DRAM without any need for refresh or error detection/correction or management of failed DRAM cells from the processor. It will also autonomously deal with cache coherency across relevant coherency domains, it will identify semaphores and all IPC traffic and process those accordingly. By doing so, it will allow processors and accelerators to share data with the lowest possible latency and the highest possible bandwidth.

Doing it this way allows for faster inter-processor communication while at the same time drastically reducing coherency traffic and speeding up all Read-Modify-Write (RMW) transactions for semaphores, increasing the linearity of speedup across processors.

### CONCLUSION

The new supercomputer server system architecture conserves power over traditional systems while providing better performance and better scale-out and affords greater security against hardware attacks.

For typical rack-scale data-intensive applications there may be far greater performance gains, up to two orders of magnitude, over traditional CPU, and system architectures.

Due to the intelligence of the (autonomous) memory command processor in the heterogeneous RAM, the entire memory subsystem is immune against attacks such as Rowhammer and Half-Double, which can wreak havoc on traditional CPU and memory architectures.

### Supercomputer Server Architecture: Novel Server-on-a-Chip Benefits

### Summary

Performance, cost, and security of today's servers do not meet the users' needs any more. The industry standard server architecture has become a bottleneck in many applications and deployments, including those at the hyperscalers and those for the edge computing revolution. A novel Server-on-a-Chip Architecture alleviates those drawbacks and provides significant advantages in cost, security, and performance as well as scale-out.

### Status Quo

Today's servers are not necessarily designed to fit the requirements of the users. Industry standard architecture servers such as x86-64 or even ARM-based servers do not consider the use case of 78% of all server deployments: Internet backend, with a LAMP stack on top of the hardware. Here are the sources for the statement that 78% of the Internet backend is run by the ISA-independent LAMP stack.
https://www.theregister.com/2021/11/23/php_foundation_formed_to_fund/

“According to Pronskiy, PUP runs “78 percent of the Web,” though the figure is misleading bearing in mind that this is partly thanks to the huge popularity of WordPress, as well as Drupal and other PHP-based content management systems. PHP is some way down the list of most popular programming languages, 11th on the most recent StackOverflow list, and sixth on the latest GitHub survey, down two places from 2019.”

If PHP runs 78% of the web, then by the very definition of the stack it must run on at least 78% of all servers. In other words, at least 78% of all servers run the xAMP stack.

These servers do not execute floating-point operations, nor do they perform any mathematically complex operations. They usually get HTTP requests and respond to those requests with proper responses. In other words, they receive integer or string input, they look up the answer to the requests in a database (and that database is optionally in-memory or on mass storage), and they respond with an integer or string answer. If the answer is not locally available, then the request gets forwarded to another server enabled to find the answer. These transactions are trivial, and all that is required is good network I/O with low latency and high levels of security, good mass storage I/O with low latency, and good integer and string processing performance—including lookup performance—in the processor array of the server itself.

The computational requirements for these servers are not high. In fact, good network I/O as well as mass storage I/O is of vastly higher importance than the ability to crunch through mathematical operations. As a result, relatively low-performance processor cores combined with smart I/O and DMA Controllers or IOMMUs for the actual data transfers themselves can serve many users on a single server. High-performance processor cores are not needed and, in some scenarios, would be detrimental to packaging density.

The higher the processor core performance, the higher the need for more and larger and more power-hungry caches, without any performance benefit to the application. As a result, there is a sweet spot of performance versus power and performance versus computational density (e.g., how many network and mass storage plus lookup operations per second can be stuffed into a 19″ rack?).

In other words, if the thermal footprint of a server that can comfortably serve 100 users is half of that of a server with high-performance processor cores but no smart I/O at the same number of users supported simultaneously, the one with the lower-performance cores but smart I/O wins. That is in effect the case for most servers on the Internet backend today.

For a 1U server, that performance level is what a 4 GHz 16-core industry-standard processor today can deliver.

### Example Solution

An analysis of typical usage patterns of servers and found that most operations on the LAMP stack can be significantly accelerated and improved by using smart I/O such as smart Network Interface Cards (NICs) and smart mass Storage Controllers as coprocessor cores in a processor with general-purpose RISC-V application processor cores. Smart NICs (dual 10 GbE and one USB 3.0 Controller for the networking device class only) with hardware accelerators that offload a great number of networking functions are augmented with two dedicated RISC-V processor cores, DMA Controllers/IOMMUs and their own pared-down versions of FreeBSD to run essentially all of the IPv4 and IPv6 network stacks, including firewall functions similar to pfSense for filtering malicious network traffic. These cores have their own memory regions that are separated from the application cores' memory regions for security and other purposes.

Mass storage accelerators for SAS, SATA, and RAID as well as ZFS with a combination of hardware and two RISC-V cores, use FreeBSD as an embedded Operating System for mass storage I/O. The processor provides 16 SAS/SATA Controllers and ports and one USB 3.0 Controller for the mass storage device class only, controlled by the two mass storage RISC-V cores. All mass storage I/O can be processed by those two embedded cores and accelerators, even including tape I/O for backup. M.2 via PCIe and SSDs are fully supported by the embedded OS. The embedded OS is part of the firmware that the supercomputer server distributes along with the processors. It is encrypted for protection.

As a result, the application cores do not need to process any mass storage I/O, not even caching for directories and similar operations. This frees them up to run the rest of the LAMP or FAMP stack and allows the 16 RISC-V application cores in conjunction with all the offload cores and accelerators to perform on par with 16 industry-standard processor cores at a lower cost and about half the power consumption.

The application processor cores operate in a Symmetric MultiProcessor (SMP) configuration.

Both the network offload complex and the mass storage offload complex include cryptographic accelerators (e.g., AES, SHA-2, and SHA-3) so that network and mass storage traffic can be encrypted and decrypted without application processor intervention.

The application processor core complex also includes a set of cryptographic accelerators (AES, SHA-2, and SHA-3) for non-network and non-mass storage related operations. For extremely security-sensitive data memory regions can be encrypted to a key pair that is inaccessible by software and can only be referenced by index. Thus, these keys or key pairs can never be stolen, even if software is compromised.

Due to the high level of integration and a more efficient interconnect between the application processor cores, the offload cores and their accelerators and the memory, even relatively lower-performance RISC-V cores compared to industry standard cores outperform existing solutions. Whereas PCIe Gen3 is limited to approximately 16 GB/s on a 16-lane interface, and all traffic is subjected to high latency, the supercomputer server solution is on-chip, has higher bandwidths (>400 GB/s), lower latency (less than 10% of PCIe Gen3) and consumes less power.

Compared to existing industry-standard solutions with a processor, a PCIe-attached external RAID Controller, and a PCIe-attached smart filtering NIC this solution provides a similar or superior throughput, consumes less power, and uses fewer components. This has of course cost implications. An industry-standard 16-core processor costs about $600-$800 (depending on clock frequency, number of DRAM Channels, size of L1 through L3 caches, and other factors), a PCIe RAID Controller costs at least $400, and a filtering dual 10 GbE NIC costs at least $1000. A performance-optimized industry standard server will cost around $2K just in active components as discussed above, whereas the new architecture Server-on-a-Chip is projected to sell for less (depending on the clock frequency) on the open market.

The Server-on-a-Chip has several other interfaces other than those mentioned above. The highest-performance interface is UHPI, Universal High-Performance Interconnect. Aside from that, the processor provides 24 PCIe Gen3 lanes for additional I/O. These are configurable as 16+8 or 16+4+4 for M.2 disks and GPUs. The processor also supports two universal USB 3 ports that do not support network or mass storage device classes on top of those mentioned above. An SPI port for SPI Flash is present, as are several I2C and SPI ports for mainboard-internal components.

Wireless LAN is supported, e.g., via one of the 10 GbE NICs.

The totality of these technologies enables better scale-out, better performance, better power consumption and better security at lower costs.

Supercomputer Server Architecture: Supercomputer Server Processors Versus x86-64

The supercomputer server uses RISC-V processor cores and special-purpose accelerator ASICs as well as smart memory for its novel architecture for the next-generation supercomputers and scalable secure edge nodes and node clusters.

Due to this novel system architecture, the supercomputer server has advantages over x86-64 (Intel and AMD) as well as ARM-based systems.

In some scenarios, the supercomputer server processor cores are modified RISC-V processors based on an open-source Instruction Set Architecture (ISA) with hardware add-ons and full hardware support for Virtualization.

Currently, FreeBSD and Linux as Operating Systems and two different Virtualization hosts are available. LLVM/CLANG and many libraries are available for custom software development, and in case that xAMP stacks fulfill all user requirements, Apache, mySQL and PHP/Perl/Python on both Linux and FreeBSD are available. This includes the entire networking stack with filtering and firewall functions, all disk I/O functions, and all mass storage functions.

The memory architecture of the supercomputer server, in conjunction with specific hardware in the processors, enables in-service updates and upgrades of firmware, VM host, Operating System and the networking and mass storage processing stack. Thus, a shutdown or restart is not needed for updates and upgrades to all crucial software.

The supercomputer server uses a clean ISA and adds computationally intensive functions as accelerator and coprocessor calls into dedicated hardware. In some implementations, the supercomputer servers use the RISC-V (more specifically RV64) architecture for the application processor, for an integer-only database processor, for embedded functions, for orchestrating computational and administrative tasks, and for management as well as security and authentication functions.

Intelligent I/O data pre-processing is accomplished via dedicated hardware assisted by dedicated processor cores to offload the application cores. The firmware for those functions is based on industry-leading FreeBSD, opnSense, or pfSense and all mass storage functions including RAID and ZFS. This is achieved internally within the Server-on-a-Chip, versus through external components in x86-64 (typically called DPUs or Data Processing Units) that are connected through low-bandwidth and high-latency PCIe to the host processor.

In some implementations, the processor core does not implement out-of-order processing to accelerate single-threaded tasks. Instead, the supercomputer server improves all aspects of inter-processor communication, access to memory, and access to accelerator cores.

The supercomputer server reduces the level of complexity that is typically exhibited in today's processors with multi-level caching. That reduces the amount and proportion of metadata taking up internal and external bandwidth.

The supercomputer server uses a unified interface for interconnecting processors, memory and accelerators that provides a vastly lower latency and higher bandwidth over QPI, OmniPath and similar current technologies. As such, the supercomputer server Inter-Processor Communication (IPC) is drastically better than everything else on the market, and it allows for a nearly linear performance scalability. One of the Universal High-Performance Interconnect ports in the processors, accelerators and smart multi-homed memories provides about the same external bandwidth as an entire Intel Xeon processor, with the pin count comparable to a single DDR 5 channel.

Since the supercomputer server uses a smart parser and memory command execution unit within the smart multi-homed memory, there is no risk of any of the Rowhammer or Half-Double type attacks against DRAM being successful.

In implementations not using speculative execution in conjunction with lazy Cache flushing, there is increased resistance to attacks such as Spectre and Meltdown. x86-64 class processors have many more vulnerabilities that are all predicated on the fact that they execute code speculatively (and therefore multiple paths are being executed quasi-simultaneously), and that the policy of the Cache Controllers to fetch code and data must support this quasi-parallel fetching, and that is combined with lazy flushing of Cache entries, leaving enough residual data in the Cache that a Cache dump can render even primary keys. In various implementations, the supercomputer server does not use lazy Cache flushing, and does not use any primary keys in software. As a result, those types of attacks will not be successful against the supercomputer server processors.

The supercomputer server BIOS/UEFI/Firmware is encrypted, and as such is not vulnerable to snooping attacks if the physical security of an edge-device is breached. The supercomputer server also encrypts memory regions that include secondary or tertiary keys, and as such even with physical access to a device, snooping will not render any unencrypted keys. All primary keys are protected from snooping even by compromised Operating System software. All firmware is authenticated and must be signed to be used for updates and upgrades.

All cryptographic functions are based on hardware within the processor, as is the Key Management Unit so that encrypted communication can take place without any impact on software and its runtime. Additionally, all the supercomputer processors have an immutable and unique ID that cannot be changed.

Primary and secondary keys are never exposed to the outside of the Key Management Unit inside the processor, and as such even hardware snooping and compromised Operating Systems will not be able to access or steal any primary or secondary keys.

In summary, the supercomputer server processors enable more linear scaling when used in large installations, they are more secure compared to x86-64, they provide hardware accelerators for cryptographic functions and a Key Management Unit (KMU) in hardware to avoid having software to deal with primary keys, and due to its compatibility with an open ISA, most relevant software including VM hosts and Operating Systems as well as the xAMP stack are available.

### Supercomputer Server Architecture: Neural Networks Applicability

Some variations of supercomputer servers implement CNN and/or DNN acceleration that speeds up the inference process. ML training for a CNN and/or DNN is accelerated using a Fused-Multiply-Add (FMA) for 64- and 128-bit integers and Floating-Point numbers. This FMA is used in a Matrix Multiplication engine, and that that is in turn used in a Tensor Processing Unit. The FMA is also used with some hardware additions to build a Fourier Transform engine. A Spiking Neural Network (SNN) is un-clocked and usable to combine many inputs and prioritize events based on the multitude and significance of input signals. For example, a particular SNN a linear array of 16 spiking neurons, and a larger array is a 64 by 64 element array of the same spiking neurons. All interconnects between the neurons (the synapses) are fixed. An array of 8 by 8 elements is connected with a crossbar to enable dynamically growing and tearing down synapses.

In some variations, an SNN is trained using tools such as PyTorch or TensorFlow to determine and set the firing thresholds and the forwarding path for spikes, and if the neurons should have a reset or a decay function built in when and if the firing threshold is not reached, and thus the neuron did not get activated.

As a specific example, the neuron for the SNN is enabled to accumulate ingress data over a preset time, fire based on a preset threshold, and forward the resulting spike to or more preset other neurons. It is enabled to configurably reset its accumulated “charge” to zero after the expiration of the preset time, and to let the register contents decay according to a log scale over time. If no input data is received, the neuron is not clocked. The neuron is only clocked and uses electric power upon receiving data, and during the accumulation period, as well as during the decay period if so configured.

### Supercomputer Server Architecture: Booting

The new system architecture for supercomputer servers implements the verification of the integrity of the bootloader and firmware image on a processor that is distinct from the host processor that is booting. A processor provides security functions to the host if needed, and uses a different methodology to startup itself, and then make a firmware image for the host available such that the host is enabled to boot from a verified and guaranteed good (“Golden”) firmware. This also enables improved resilience in case a firmware image is corrupted by external influences.

### Supercomputer Server Architecture Additional Information

FIGS. 1-13 and 16 disclose various aspects of example supercomputer server architecture techniques that enable improved supercomputer server implementations, including improved supercomputer component interconnection technology and improved supercomputer memory system technology.

A system of one or more computers is configurable to perform particular operations or actions by virtue of having software, firmware, hardware, or a combination of them installed on the system that in operation causes or cause the system to perform the actions. One or more computer programs is configurable to perform particular operations or actions by virtue of including instructions that, when executed by data processing apparatus, cause the apparatus to perform the actions. One general aspect includes a system. The system also includes one or more processors; one or more smart memories, and point-to-point interconnect that enables the processors and the smart memories to communicate with each other as peers. Other embodiments of this aspect include corresponding computer systems, apparatus, and computer programs recorded on one or more computer storage devices, each configured to perform the actions of the methods.

Implementations optionally include one or more of the following features. The system optionally includes one or more accelerators, and where the point-to-point interconnect enables the accelerators to communicate with the processors and the smart memories as peers. The processors, the smart memories, and the accelerators are enabled to communicate and respond to backpressure indicators. At least one of the smart memories is enabled to post all writes. At least one of the smart memories is enabled to post writes without regard to physical address, virtual address, and/or metadata associated with an address. At least one of the smart memories is enabled to map physical addresses of one or more memory components into one or more contiguous physically addressable regions. The memory components optionally include at least one volatile memory component and at least one non-volatile memory component. Implementations of the described techniques optionally include hardware, a method or process, or computer software on a computer-accessible medium.

One general aspect includes a method. The method also includes a switch fabric communicating data between agents coupled to the switch fabric; each of the agents providing backpressure information to the switch fabric; the switch fabric communicating the backpressure information to the agents; and each of the agents responding to the backpressure information from the switch fabric by conditionally disabling providing the data to the switch fabric, and where the agents optionally include one or more processors and one or more smart memories. Other embodiments of this aspect include corresponding computer systems, apparatus, and computer programs recorded on one or more computer storage devices, each configured to perform the actions of the methods.

Implementations optionally include one or more of the following features. The method where the agents further optionally include one or more accelerators. The method optionally includes each of the agents responding to the backpressure information from the switch fabric by conditionally enabling providing the data to the switch fabric. The method optionally includes each of the agents determining the backpressure information to provide to the switch fabric responsive to fullness of one or more queues of the respective agent. The method optionally includes at least one of the smart memories posting all writes. The method optionally includes at least one of the smart memories mapping physical addresses of one or more memory components into one or more contiguous physically addressable regions. Implementations of the described techniques optionally include hardware, a method or process, or computer software on a computer-accessible medium.

One general aspect includes a system. The system also includes a plurality of agents that optionally includes one or more processors, one or more smart memories, and one or more accelerators; and a switch fabric that enables the agents to communicate data and backpressure information amongst each other. Other embodiments of this aspect include corresponding computer systems, apparatus, and computer programs recorded on one or more computer storage devices, each configured to perform the actions of the methods.

Implementations optionally include one or more of the following features. The system where each of the agents is enabled to determine and provide backpressure information to the switch fabric. Each of the agents is responsive to backpressure information from the switch fabric. At least one of the smart memories optionally includes at least one volatile memory component and at least one non-volatile memory component. At least one of the smart memories is enabled to post all writes. At least one of the smart memories is enabled to post writes without regard to physical address, virtual address, and/or metadata associated with an address. At least one of the smart memories is enabled to map physical addresses of one or more memory components into one or more contiguous physically addressable regions. Implementations of the described techniques optionally include hardware, a method or process, or computer software on a computer-accessible medium.

A system of one or more computers is configurable to perform particular operations or actions by virtue of having software, firmware, hardware, or a combination of them installed on the system that in operation causes or cause the system to perform the actions. One or more computer programs is configurable to perform particular operations or actions by virtue of including instructions that, when executed by data processing apparatus, cause the apparatus to perform the actions. One general aspect includes a system. The system also includes a first port enabled for connection to a second port; and interconnect connecting the first port to the second port, and where the first port and the second port are enabled to communicate data and backpressure information between peers coupled thereto. Other examples of this aspect include corresponding computer systems, apparatus, and computer programs recorded on one or more computer storage devices, each configured to perform the actions of the methods.

Implementations optionally include one or more of the following features. The system optionally includes a first switch that optionally includes the first port and a second switch that optionally includes the second port. The system optionally includes a first server-on-a-chip that optionally includes the first switch and a second server-on-a-chip that optionally includes the second port. The system optionally includes a first printed circuit board that optionally includes the first server-on-a-chip and a second printed circuit board that optionally includes the second server-on-a-chip. The data and the backpressure information are communicated at least in part via the optical coupling. Implementations of the described techniques optionally include hardware, a method or process, or computer software on a computer-accessible medium.

One general aspect includes a system. The system also includes a first scalable parallel interface; a second scalable parallel interface; and a finite state machine coupling the first scalable parallel interface to the second scalable parallel interface, and where (1) the first scalable parallel interface is compatible with communicating with a processor core via a third scalable parallel interface of the processor core and (2) the communicating optionally includes communicating data and communicating backpressure information. Other examples of this aspect include corresponding computer systems, apparatus, and computer programs recorded on one or more computer storage devices, each configured to perform the actions of the methods.

Implementations optionally include one or more of the following features. The system optionally includes a chiplet that optionally includes the first scalable parallel interface, the second scalable parallel interface, and the finite state machine. The chiplet is a first chiplet that optionally includes a second chiplet that optionally includes the processor core and the third scalable parallel interface. The chiplet is a first chiplet that optionally includes a second chiplet that optionally includes a fourth scalable parallel interface, an interface PHY enabled to communicate with an element external to the second chiplet, and an interface adapter coupling the fourth scalable parallel interface to the interface PHY. Implementations of the described techniques optionally include hardware, a method or process, or computer software on a computer-accessible medium.

One general aspect includes a system. The system also includes a translation lookaside buffer enabled to map non-contiguous physical memory portions into one or more contiguous memory portions; scratchpad memory usable to post writes, a plurality of DRAM components, cryptographic key memory, a command interpreter enabled to intercept memory commands, and cache-control hardware enabled to perform one or more cache-control protocols. Other examples of this aspect include corresponding computer systems, apparatus, and computer programs recorded on one or more computer storage devices, each configured to perform the actions of the methods.

Implementations optionally include one or more of the following features. The system where the translation lookaside buffer, the scratchpad memory, the plurality of DRAM components, the cryptographic key memory, the command interpreter, and the cache-control hardware are operable collectively as a smart memory. The system optionally includes one or more processors coupled the smart memory. Implementations of the described techniques optionally include hardware, a method or process, or computer software on a computer-accessible medium.

A system of one or more computers is configurable to perform particular operations or actions by virtue of having software, firmware, hardware, or a combination of them installed on the system that in operation causes or cause the system to perform the actions. One or more computer programs is configurable to perform particular operations or actions by virtue of including instructions that, when executed by data processing apparatus, cause the apparatus to perform the actions. One general aspect includes a method of improving performance of a memory of a supercomputer. The method also includes using smart memory to hide maintenance operations of the memory from agents accessing the memory, thereby improving the performance of the memory; and where the hiding optionally includes the smart memory posting all writes to the memory from the agents. Other examples of this aspect include corresponding computer systems, apparatus, and computer programs recorded on one or more computer storage devices, each configured to perform the actions of the methods.

Implementations optionally include one or more of the following features. The method where the memory optionally includes dynamic memory, and the maintenance operations optionally include any combination of: scrubbing; refreshing; error correcting; and error logging. The memory optionally includes flash memory, and the maintenance operations optionally include any combination of: garbage collection; wear leveling related operations; error correcting; and error logging. Implementations of the described techniques optionally include hardware, a method or process, or computer software on a computer-accessible medium.

One general aspect includes a method of improving performance of a memory of a supercomputer. The method also includes using smart memory to hide underlying implementation details of the memory from agents accessing the memory, thereby improving the performance of the memory; and where the hiding optionally includes the smart memory mapping addresses from the agents so that a plurality of physical memory components appears contiguous to the agents. Other examples of this aspect include corresponding computer systems, apparatus, and computer programs recorded on one or more computer storage devices, each configured to perform the actions of the methods.

One general aspect includes a method of improving resilience of a memory of a supercomputer. The method also includes using smart memory to hide underlying implementation details of the memory from agents accessing the memory, thereby improving the resilience of the memory; and where the hiding optionally includes the smart memory posting all writes to the memory from the agents. Other examples of this aspect include corresponding computer systems, apparatus, and computer programs recorded on one or more computer storage devices, each configured to perform the actions of the methods.

Implementations optionally include one or more of the following features. The method where the hiding enables resilience against attack vectors optionally include any combination of: spectre; meltdown; rowhammer; and halfrow. Implementations of the described techniques optionally include hardware, a method or process, or computer software on a computer-accessible medium.

One general aspect includes a method of reducing latency in a system optionally include a plurality of system agents. The method also includes accelerated signaling of backpressure release responsive to an egress queue emptying to a watermark; and distributing, by a switch fabric, the backpressure release to contention-contributing agents that contributed to contention of the switch fabric, and where the plurality of system agents optionally include the contention-contributing agents; and where a single integrated circuit die optionally include the switch fabric and at least one of the system agents. Other examples of this aspect include corresponding computer systems, apparatus, and computer programs recorded on one or more computer storage devices, each configured to perform the actions of the methods.

Implementations optionally include one or more of the following features. The method where the watermark is a first watermark, the contention-contributing agents are first contention-contributing agents, and optionally include: accelerated signaling of backpressure responsive to the egress queue filling to a second watermark; and distributing, by the switch fabric, the backpressure to second contention-contributing agents that are contributing to contention of the switch fabric, and where the plurality of system agents optionally include the second contention-contributing agents. The first watermark is less than the second watermark. The egress queue is implemented using a systolic array. Implementations of the described techniques optionally include hardware, a method or process, or computer software on a computer-accessible medium.

One general aspect includes a method of reducing latency in a system optionally include a plurality of system agents. The method also includes accelerated signaling of backpressure responsive to an egress queue filling to a watermark; and distributing, by a switch fabric, the backpressure to contention-contributing agents that are contributing to contention of the switch fabric, and where the plurality of system agents optionally include the contention-contributing agents; and where a single integrated circuit die optionally include the switch fabric and at least one of the system agents. Other examples of this aspect include corresponding computer systems, apparatus, and computer programs recorded on one or more computer storage devices, each configured to perform the actions of the methods.

Implementations optionally include one or more of the following features. The method where the watermark is a first watermark and optionally include: accelerated signaling of backpressure release responsive to the egress queue emptying to a second watermark; and distributing, by the switch fabric, the backpressure release to the contention-contributing agents. The first watermark is greater than the second watermark. Each of the contention-contributing agents have at least one respective entry in the egress queue. The distributing optionally include the switch fabric providing one or more messages to the contention-contributing agents. The distributing optionally include the switch fabric driving one or more signals dedicated to backpressure signaling and where the one or more signals are coupled to the contention-contributing agents. At least one of the contention-contributing agents optionally include a port coupled to a corresponding port of the switch fabric. For at least one of the contention-contributing agents, the distributing optionally include providing the backpressure to the at least one contention-contributing agent via a port of the switch fabric coupled to a corresponding port of the at least one contention-contributing agent. The port of the switch fabric is directly coupled to the corresponding port of the at least one contention-contributing agent. The port of the switch fabric is indirectly coupled to the corresponding port of the at least one contention-contributing agent via another switch fabric. The port of the switch fabric is coupled to the corresponding port of the at least one contention-contributing agent via at least one other switch fabric. The single integrated circuit die optionally include the other switch fabric. The single integrated circuit die is a first integrated circuit die and a second integrated circuit die optionally include the other switch fabric. A multi-chip module optionally includes the first integrated circuit die and the second integrated circuit die. A first component mounted on a printed circuit board optionally include the first integrated circuit die and a second component mounted on the printed circuit board optionally include the second integrated circuit die. A first component mounted on a first printed circuit board optionally include the first integrated circuit die and a second component mounted on a second printed circuit board optionally include the second integrated circuit die, the distributing optionally include the first printed circuit board and the second printed circuit board communicating with each other via at least one cable coupling the first and the second printed circuit boards, and the at least one cable is an electrical cable or an optical cable. The port of the switch fabric is dedicated to the corresponding port of the at least one contention-contributing agent. The port of the switch fabric shared with other agents is dedicated to the corresponding port of the at least one contention-contributing agent. Implementations of the described techniques optionally include hardware, a method or process, or computer software on a computer-accessible medium.

One general aspect includes a method of reducing latency in a multi-agent system. The method also includes signaling backpressure responsive to an egress queue being filled to a first watermark; and distributing the backpressure by a switch fabric to a plurality of agents of the multi-agent system, and where a single integrated circuit die optionally include the switch fabric and at least one of the agents of the plurality of agents. Other examples of this aspect include corresponding computer systems, apparatus, and computer programs recorded on one or more computer storage devices, each configured to perform the actions of the methods.

Implementations optionally include one or more of the following features. The method where the plurality of agents optionally includes all agents having at least one entry in the egress queue. The backpressure is communicated by one or more signal lines enabled to indicate a mutually exclusive one of a plurality of backpressure indications. The plurality of backpressure indications optionally includes an indication to disable sending and an indication to enable sending. The backpressure is communicated by one or more backpressure messages enabled to indicate a mutually exclusive one of a plurality of backpressure indications. The switch fabric is a first switch fabric, and one or more of the agents are coupled to the first switch fabric via a second switch fabric. The single integrated circuit die optionally include the second switch fabric. A multi-chip module optionally includes a plurality of integrated circuit dice that optionally include the single integrated circuit die. The single integrated circuit die further optionally include the second processor. A supercomputer server enabled to perform the method. Implementations of the described techniques optionally include hardware, a method or process, or computer software on a computer-accessible medium.

One general aspect includes a method of increasing scalability in a multiprocessor system. The method also includes exchanging information between first and second processors of the multiprocessor system; and where the first and the second processors are coupled to respective first and second ports of a switch, where the exchanging optionally includes switching the information between the first and second ports of the switch, and where an integrated circuit die optionally includes the first processor and the switch, thereby increasing the scalability. Other examples of this aspect include corresponding computer systems, apparatus, and computer programs recorded on one or more computer storage devices, each configured to perform the actions of the methods.

Implementations optionally include one or more of the following features. The method where the exchanging further optionally includes exchanging backpressure indications between the switch and the first and the second processors. The switch optionally includes a switch fabric. The switch fabric is non-blocking. The information is optionally included in one or more packets. Implementations of the described techniques optionally include hardware, a method or process, or computer software on a computer-accessible medium.

One general aspect includes a method of reducing latency in a multiprocessor system. The method also includes exchanging information between first and second processors of the multiprocessor system; and where the first and the second processors are coupled to respective first and second ports of a switch, where the exchanging optionally includes switching the information between the first and second ports of the switch, and where the exchanging further optionally includes the switch conditionally providing respective backpressure indications to selected ones of the first and the second processors, and in response, each of the first and the second processors that receive a backpressure indication control a respective rate at which the respective processor communicates portions of the information to the switch, thereby reducing the latency. Other examples of this aspect include corresponding computer systems, apparatus, and computer programs recorded on one or more computer storage devices, each configured to perform the actions of the methods.

Implementations optionally include one or more of the following features. The method where an integrated circuit die optionally includes the first processor and the switch. Responsive to the respective backpressure indication indicating a first of at least two mutually exclusive conditions, the respective processor is disabled from providing the portions of the information to the switch; and where responsive to the respective backpressure indication indicating a second of the mutually exclusive conditions, the respective processor is enabled to resume providing the portions of the information to the switch. The method optionally includes: setting the respective backpressure indications to indicate the first of the at least two mutually exclusive conditions based on respective queues of a switch fabric of the switch being full to a first watermark; and setting the respective backpressure indications to indicate the second of the at least two mutually exclusive conditions based on the respective queues being full to a second watermark. The first watermark is greater than the second watermark. The respective rate is controllable between a minimum rate and a maximum rate; where responsive to the respective backpressure indication indicating a first of at least two mutually exclusive conditions, the respective rate is set to the minimum rate; and where responsive to the respective backpressure indication indicating a second of at the mutually exclusive conditions, the respective rate is set to the maximum rate. The minimum rate is zero. The switch conditionally providing the respective backpressure indications is conditional based on fullness of queue entries in a switch fabric of the switch. The selected ones of the first and the second processors are based on fullness of queue entries in a switch fabric of the switch. A supercomputer server enabled to perform the method. Implementations of the described techniques optionally include hardware, a method or process, or computer software on a computer-accessible medium.

One general aspect includes a supercomputer server enabling increased scalability. The supercomputer server also includes a switch; and a plurality of processors; and where each of the processors is enabled to exchange information via at least one respective port of the switch, and where the supercomputer server optionally includes one or more integrated circuits, one of which optionally includes at least one of the processors and the switch, thereby enabling the increased scalability. Other examples of this aspect include corresponding computer systems, apparatus, and computer programs recorded on one or more computer storage devices, each configured to perform the actions of the methods.

Implementations optionally include one or more of the following features. The supercomputer server where the switch optionally includes a non-blocking switch fabric. The non-blocking switch fabric is contention reduced via backpressure information dissemination to the processors. The non-blocking switch fabric is further contention reduced via the processors responding to the backpressure information by controlling information bandwidth to the switch. Implementations of the described techniques optionally include hardware, a method or process, or computer software on a computer-accessible medium.

One general aspect includes a supercomputer server enabling reduced latency. The supercomputer server also includes a switch; and a plurality of processors; and where each of the processors is enabled to exchange information via at least one respective port of the switch, and where the switch is enabled to exchange backpressure information with the processors, thereby enabling the reduced latency. Other examples of this aspect include corresponding computer systems, apparatus, and computer programs recorded on one or more computer storage devices, each configured to perform the actions of the methods.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A system, comprising:
one or more processors;
one or more smart memories; and
point-to-point interconnect that enables the processors and the smart memories to communicate with each other as peers.

2. The system of claim 1, further comprising one or more accelerators, and wherein the point-to-point interconnect enables the accelerators to communicate with the processors and the smart memories as peers.

3. The system of claim 2, wherein the processors, the smart memories, and the accelerators are enabled to communicate and respond to backpressure indicators.

4. The system of claim 1, wherein at least one of the smart memories is enabled to post all writes.

5. The system of claim 1, wherein at least one of the smart memories is enabled to post writes without regard to physical address, virtual address, and/or metadata associated with an address.

6. The system of claim 1, wherein at least one of the smart memories is enabled to map physical addresses of one or more memory components into one or more contiguous physically addressable regions.

7. The system of claim 6, wherein the memory components comprise at least one volatile memory component and at least one non-volatile memory component.

8. A method comprising:
a switch fabric communicating data between agents coupled to the switch fabric;
each of the agents providing backpressure information to the switch fabric;
the switch fabric communicating the backpressure information to the agents; and
each of the agents responding to the backpressure information from the switch fabric by conditionally disabling providing the data to the switch fabric, and wherein the agents comprise one or more processors and one or more smart memories.

9. The method of claim 8, wherein the agents further comprise one or more accelerators.

10. The method of claim 8, further comprising each of the agents responding to the backpressure information from the switch fabric by conditionally enabling providing the data to the switch fabric.

11. The method of claim 8, further comprising each of the agents determining the backpressure information to provide to the switch fabric responsive to fullness of one or more queues of the respective agent.

12. The method of claim 8, further comprising at least one of the smart memories posting all writes.

13. The method of claim 8, further comprising at least one of the smart memories mapping physical addresses of one or more memory components into one or more contiguous physically addressable regions.

14. A system, comprising:
a plurality of agents that comprise one or more processors, one or more smart memories, and one or more accelerators; and
a switch fabric that enables the agents to communicate data and backpressure information amongst each other.

15. The system of claim 14, wherein each of the agents is enabled to determine and provide backpressure information to the switch fabric.

16. The system of claim 15, wherein each of the agents is responsive to backpressure information from the switch fabric.

17. The system of claim 14, wherein at least one of the smart memories is enabled to post all writes.

18. The system of claim 14, wherein at least one of the smart memories is enabled to post writes without regard to physical address, virtual address, and/or metadata associated with an address.

19. The system of claim 14, wherein at least one of the smart memories is enabled to map physical addresses of one or more memory components into one or more contiguous physically addressable regions.

20. The system of claim 16, wherein at least one of the smart memories comprises at least one volatile memory component and at least one non-volatile memory component.
